(19) United States
(12) Patent Application Publication
(10) Pub. No.: US 2015/0141107 A1
(43) Pub. Date: May 21, 2015

(54) Methods of Administering Low Point Wagering Games

(71) Applicant: Bally Gaming, Inc., Las Vegas, NV (US)

(72) Inventors: Benjamin J. Kowalski, Bethel Park (PA); Jeremiah J. LeClerc, Canonsburg, PA (US)

(21) Appl. No.: 14/536,138

(22) Filed: Nov. 7, 2014

Related U.S. Application Data
(60) Provisional application No. 61/905,900, filed on Nov. 19, 2013.
(60) Provisional application No. 61/939,528, filed on Feb. 13, 2014.

(51) Int. Cl. G07F 17/32; A63F 9/24; A63F 1/00

(52) U.S. Cl. CPC G07F 17/3293; A63F 1/00; A63F 9/24; G07F 17/3258; A63F 2001/005
USPC 463/13; 273/292

(57) ABSTRACT

Methods of administering wagering games include accepting at least one of a play wager, a hand comparison wager, and a hand composition wager from at least one participating player and dealing a at least a portion of a player hand to the at least one participating player. The at least one participating player may fold the play wager or place a raise wager and may receive additional cards to form a complete player hand. The at least one participating player may receive a payout for the play wager, the raise wager, and the hand comparison wager for having a point total equal to or lower than either a predetermined point total or lower than a dealer point total and may receive a payout for the hand composition wager when the complete player hand includes at least one ace. Systems, gaming tables, and electronic gaming machines may perform such wagering methods.

### CROSS-REFERENCE TO RELATED APPLICATIONS

This application claims the benefit of U.S. Provisional Patent Application Ser. No. 61/905,900, filed Nov. 19, 2013, by Kowalski et al., and U.S. Provisional Patent Application Ser. No. 61/939,528, filed Feb. 13, 2014, by Kowalski et al., the disclosure of each of which is incorporated herein in its entirety by this reference.

### FIELD

This disclosure relates generally to methods of administering wagering games for casinos and other gaming establishments, and related systems and apparatuses. More specifically, disclosed embodiments relate to methods of administering wagering games involving at least one of the evaluation and comparison of point totals of player hands involving multiple optional wagers wherein winning outcomes are determined at least partially based on low point totals.

### BACKGROUND

Poker is a popular wagering game played in casinos and other gaming establishments. Many variants of poker have been developed, including, without limitation, five-card draw, five-card stud, seven-card stud, MISSISSIPPI STUD™, TEXAS HOLD'EM™, ULTIMATE TEXAS HOLD'®, and LET IT RIDE® poker. Decks of 52 cards or representations of cards are often used in playing these games.

Blackjack is another popular wagering game played in casinos and other gaming establishments. Many variants of blackjack have been developed, including, without limitation, games including various side wagers and bonus wagers.

However, basic player strategy, and relative value of hands in poker games and blackjack games may be difficult for some players to understand. Therefore, some players may not desire to learn the basic strategies to such games and may not desire to participate in such wagering games.

There is a market for new and more interesting wagering games with easy to understand and entertaining game play. There is a growing market for themed-based card games that appeal to gamblers who seek additional betting options and more entertainment than found in the prior art.

### BRIEF SUMMARY

In some embodiments, the present disclosure includes a method of administering a wagering game. The method includes accepting at least one of a play wager from a player to participate in a game by receiving at least a first tangible, monetarily valuable gaming chip in a designated play wager area on a play surface of a play table, a hand comparison wager from the player to participate in a hand comparison game by receiving at least a second tangible, monetarily valuable gaming chip in a designated hand comparison wager area on the play surface of the play table, and a hand composition wager from the player to participating in a hand composition game by receiving at least a third tangible, monetarily valuable gaming chip in a designated hand composition wager area on the play surface of the play table. The method further includes delivering player cards from a deck of physical playing cards comprising a set of at least one 52-card deck of standard playing cards from a card-handling device configured to present packs of randomized cards for delivery to the player in a player card receiving area on the play surface of the play table to form a partial player hand, allowing the player to inspect the partial player hand, if the player has placed the play wager, accepting an optional raise wager from the player by receiving at least a fourth tangible, monetarily valuable gaming chip in a raise wager area on the play surface of the play table or receiving an indication of folding from the player, delivering additional player cards from the card-handling device to the player in the player card receiving area on the play surface of the play table to form a complete player hand if the player placed at least one of the hand comparison wager, the hand composition wager, and the raise wager, delivering a set of dealer cards from the card-handling device to a dealer card receiving area on the play surface of the play table, resolving the play wager by paying the player a payout on the play wager when a player point total of the complete player hand is less than or equal to a predetermined value, resolving the raise wager if the player has placed the raise wager by paying the player a payout on the raise wager when the player point total of the complete player hand is less than or equal to the predetermined value, resolving the hand comparison wager by paying the player a payout on the hand comparison wager when the player point total of the complete player hand is less than a point total of the set of dealer cards, and resolving the hand composition wager by paying the player a payout on the hand composition wager when the complete player hand includes at least one ace.

In additional embodiments, the present disclosure includes a method of administering a wagering game. The method includes providing a playing device layout comprising at least one player position and a dealer area, the at least one player position of the playing device layout including a play wager area, a raise wager area, a hand comparison wager area, and a hand composition wager area, the play wager area, the raise wager area, the hand comparison wager area, and the hand composition wager area each defined by separate insignia displayed on the playing device layout, the dealer area including a dealer card receiving area, accepting at least one of a play wager of at least one tangible, monetarily valuable gaming chip from at least one player at the play wager area, a hand comparison wager of at least one tangible, monetarily valuable gaming chip at the hand comparison wager area, and a hand composition wager of at least one tangible, monetarily valuable gaming chip at the hand composition wager area from the at least one player, dealing player cards to the at least one player to form at least a portion of a player hand from a set of physical playing cards comprising at least one 52-card deck of standard playing cards utilizing a card-handling device configured to present cards for delivery, allowing the at least one player to inspect at least one card of the player hand, accepting a raise wager of at least one tangible, monetarily valuable gaming chip at the raise wager area from the at least one player, allowing the at least one player to inspect a remaining portion of the player hand, dealing dealer cards to a dealer at the dealer card receiving area from the card-handling device, determining a player point total of the player hand, determining a dealer point total of the dealer cards, paying a payout of at least one tangible, monetarily valuable gaming chip on at least one of the play wager and the raise wager when the player point total is less than or equal to a predetermined point total, paying a hand comparison wager payout of at least one tangible, monetarily valuable gaming chip on the hand comparison wager if the player point total is less than the dealer point total, and paying a hand composition wager payout of at least one tangible, monetarily valuable gaming chip on the hand composition wager if the player hand includes at least one ace.

In yet additional embodiments, the present disclosure includes a method of administering a wagering game over a network utilizing a processor. The method includes receiving, at a server comprising at least one processor, an electronic signal indicating that at least one of a play wager, a hand comparison wager, and a hand composition wager is accepted from a player, determining, utilizing the server, a partial player hand to the player, the partial player hand including at least two playing cards from a deck of playing cards comprising at least a 52-card set of standard playing cards, providing, with the server, the partial player hand to a user device associated with the player for displaying the partial player hand on the associated user device, determining, utilizing the server, a complete player hand comprising the at least two player cards and additional player cards, providing, with the server, the complete player hand to the user device associated with the player for displaying the complete player hand on the associated user device, determining, utilizing the server, a dealer hand from the deck of playing cards, and providing, with the server, the dealer hand to the user device associated with the player for displaying the dealer hand on the associated user device. The method further includes resolving, with the server, at least one of authorizing, at the server, payment of a play wager payout to the player when a player point total of the player hand is lower than or equal to a predetermined point total, authorizing, at the server, payment of a hand comparison wager payout when the point total of the complete player hand is lower than a point total of the dealer hand, and authorizing, at the server, payment of a hand composition wager payout when the complete player hand includes at least one ace.

Yet other embodiments may comprise apparatuses and systems for administering wagering games according to embodiments of the disclosure.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is an enlarged diagram of a player position of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of wagering games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 illustrates an embodiment of data flows between various applications/services for supporting the game, feature or utility of the present disclosure for mobile/interactive gaming; and

FIG. 12 is a schematic of a scratch card implementation of a wagering game in accordance with this disclosure.

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked” and “player-banked” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local game, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering.

Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

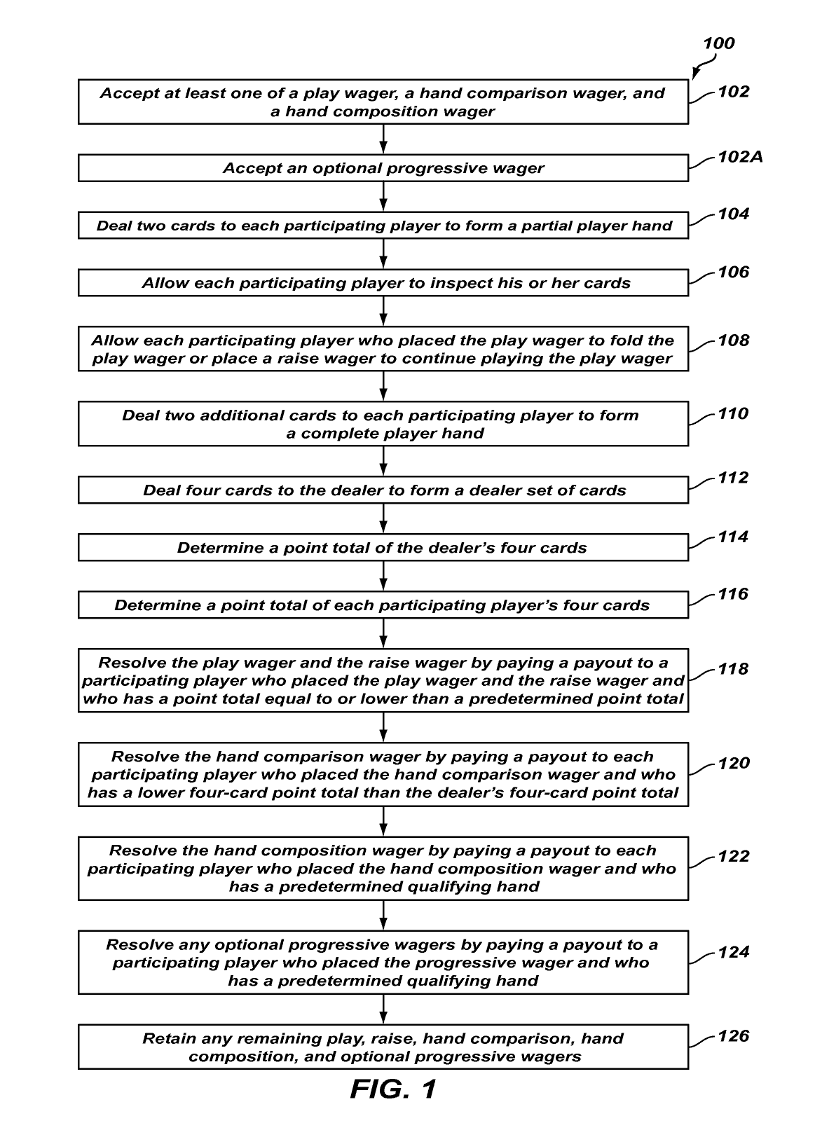

Referring to FIG. 1, a flowchart diagram of a method 100 of administering a wagering game is shown. Generally, the method 100 includes administering a wagering game including dealing a predetermined number of cards to a dealer and to each participating player who placed one or more wagers on the wagering game. For example, each participating player may place one or more of a play wager, a hand comparison wager, a hand composition wager, and any other optional bonus or progressive wagers as discussed below. The method 100 includes determining a point total of each participating player's cards and the cards of the dealer and determining one or more winners by determining participating players with a point total lower than or equal to a predetermined point total, with a point total lower than a point total of the dealer, and/or a predetermined hand composition (e.g., a predetermined number of aces).

Each participating player may place at least one of a play wager, a hand comparison wager, and a hand composition wager. In other words, to participate in a particular round of the wagering game, a player must place one of the three foregoing wagers. In some embodiments, the player makes a mandatory play wager and optionally makes a hand comparison and hand composition wagers. After placing at least one of the play wager, the hand comparison wager, and the hand composition wager, each participating payer may be dealt a partial player hand and may have the opportunity to inspect the partial player hand. If the participating player placed the play wager, the participating player may have the opportunity to place a raise wager to receive a complete player hand. The partial player hand may be formed by two cards held by each participating player and the complete player hand may be formed by four cards held by each participating player. Participating players who placed the play wager and the raise wager and who have a point total equal to or lower than a predetermined point total may receive a payout for the play wager and the raise wager. Players who placed the hand comparison wager and who have a lower point total than a dealer point total may receive a payout for the hand comparison wager. Players who placed the hand composition wager and have a complete player hand including a predetermined qualifying hand (e.g., at least one ace) may receive a payout for the hand composition wager.

The method 100 may begin with the making of at least one of a play wager, a hand comparison wager, and a hand composition wager, accepting at least one of the play wager, the hand comparison wager, and the hand composition wager, or receiving an indication that at least one of the play wager, the hand comparison wager, and the hand composition wager has been made or received from each participating player, or at a location associated with a particular player, as indicated at operation 102. At least one of the play wager, the hand comparison wager, and the hand composition wager may be accepted from each player wishing to participate in the upcoming wagering game (which may represent the start of one game play or round where a game session may comprise one or more individual game plays). Each participating player may place at least one of the play wager, the hand comparison wager, and the hand composition wager to participate in a round of game play. Thus, each of the play wager, the hand comparison wager, and the hand composition wager may be optional, but a participating player may place one or more of the play wager, the hand comparison wager, and the hand composition wager to participate in and initiate a round of play. Participating players may place the play wager, the hand comparison wager, and the hand composition wager in any combination. In some embodiments with a golf motif, the play wager may be referred to as a “Front 9” wager, the hand comparison wager may be referred to as a “Skins” wager or a “point total” wager, and the hand composition wager may be referred to as a “Gopher” wager or a “card frequency” wager.

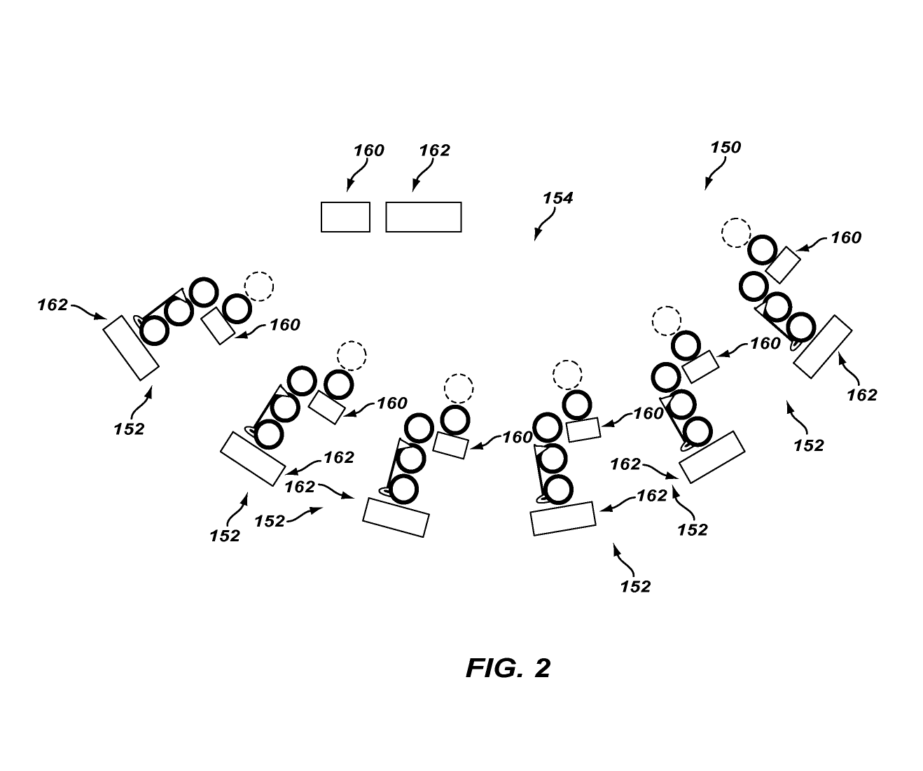

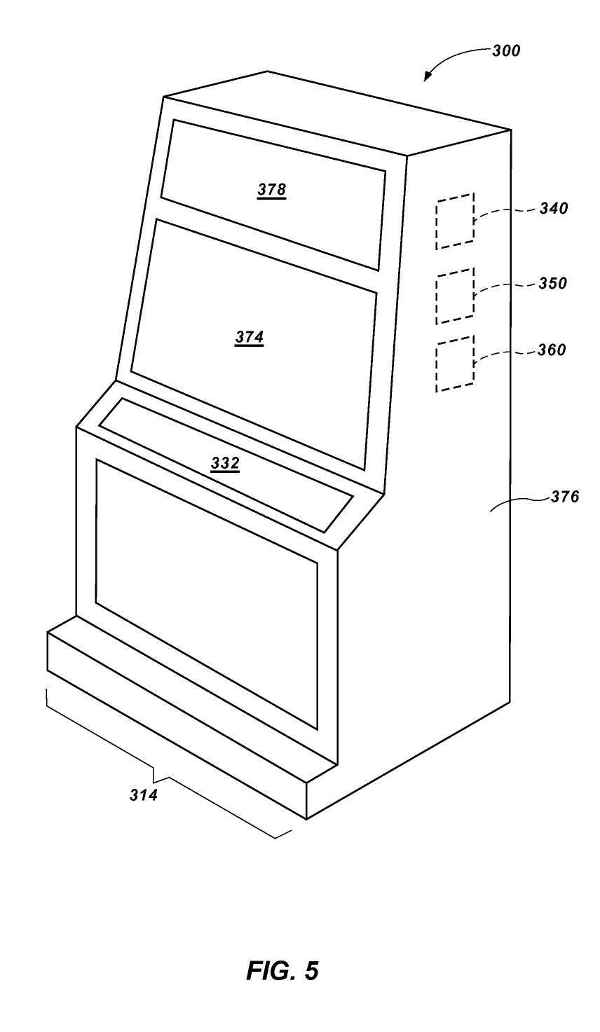

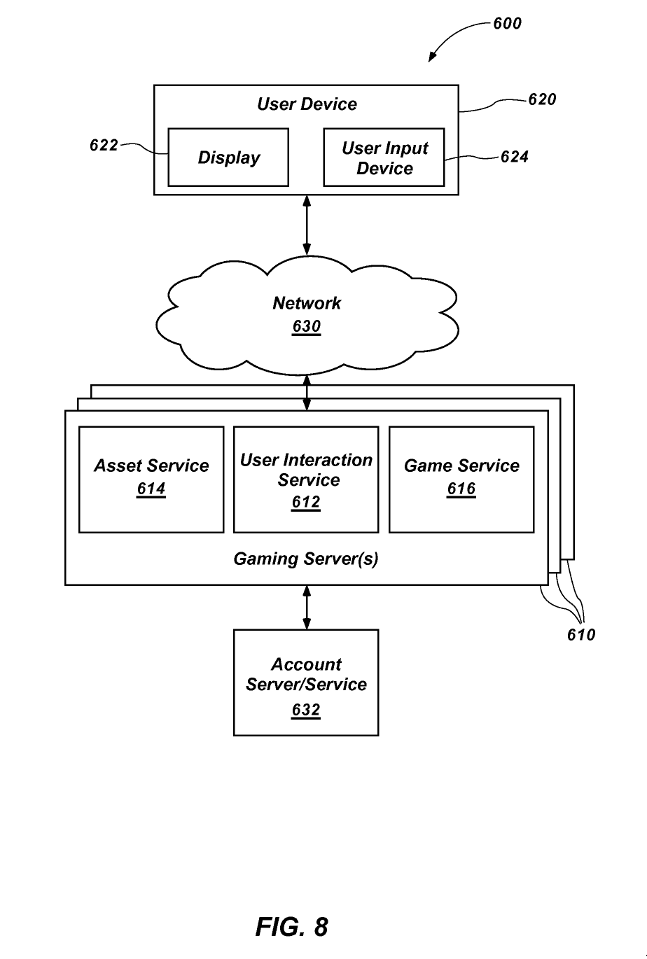

As a specific, non-limiting example, the individual players may begin a gaming session at an electronic gaming table 150, 400, or 500 (see FIGS. 2, 6, and 7) (e.g., by logging into a player account, by swiping a player account card, or by swiping a credit card) and interact with personal interface devices 332, 416a, 416b, 416c, 416d, 416e, 416f, 416g, 532a, 532b, 532c, 532d, 532e, 620 (see FIGS. 5 through 9) (e.g., touch screens, keyboards, buttons, switches, etc.) to authorize placement of the one or more wagers. The wagers may be provided, for example, by placing physical money or physical representations of money (e.g., poker chips) in a designated area of a gaming table 150, 400, 500 (see FIGS. 2, 6, and 7), by displaying digital representations of money in a designated area of at least one display screen 374, 416a, 416b, 416c, 416d, 416e, 416f, 416g, 430, 532a, 532b, 532c, 532d, 532e, 560, 564, or 658 (see FIGS. 5 through 7 and 10), or by displaying a monetary amount of the wager on at least one display screen 374, 416a, 416b, 416c, 416d, 416e, 416f, 416g, 430, 532a, 532b, 532c, 532d, 532e, 560, 564, or 658 (see FIGS. 5 through 7 and 10), which may be remotely located from a dealer or game server 610 (see FIG. 8).

The one or more wagers may be accepted, for example, by electronically accepting funds from a player account or other credit authorized via one or more communications media (e.g., via the Internet, wireless communications, land line) on a remote electronic device (e.g., a personal computer, a laptop, a tablet computer, or a smartphone) by player input; electronically accepting funds from a player account authorized on a local wagering game administration device in a casino by player input; or physically placing money or representations of money (e.g., chips) on a table at a live game in a casino. Suitable network architecture for electronically accepting funds from a player account authorized on a remote device may comprise, for example, the network gaming architecture disclosed in U.S. patent application Ser. No. 13/353,194, filed Jan. 18, 2012, to Costello et al., and U.S. patent application Ser. No. 13/609,031 filed Sep. 10, 2012 to Costello et al., the disclosure of each of which is incorporated herein in its entirety by this reference. Suitable local wagering game administration devices may comprise, for example, the chipless tables disclosed in U.S. Patent Application Pub. No. 2010/0016050, published Jan. 21, 2010, to Snow et al., now U.S. Pat. No. 8,262,475, issued Sep. 11, 2012, the disclosure of which is incorporated herein in its entirety by this reference.

A play wager may be accepted from at least one participating player. The play wager may be accepted before any cards are dealt, or at least before the at least one participating player is allowed to inspect his or her player cards. As will be explained in more detail below, each participating player who places the play wager may have the option to either forfeit the play wager or place a raise wager that the participating player's complete hand will have a point total equal to or lower than a predetermined point total.

A hand comparison wager may be accepted from the at least one participating player. The hand comparison wager may be accepted before any cards are dealt, or at least before the at least one participating player is allowed to inspect his or her player cards. The hand comparison wager may include, for example, a wager that the player cards of the at least one participating player will have a lower point total than a point total of another set of cards in the game (e.g., the dealer's cards).

A hand composition wager may be accepted from the at least one participating player. The hand composition wager may be accepted before any cards are dealt, or at least before the at least one participating player is allowed to inspect his or her player cards. The hand composition wager may include, for example, a wager that the player cards of the at least one participating player will include a predetermined qualifying hand (e.g., at least one ace). In some embodiments, a greater number of aces may qualify the at least one participating player for a higher payout, as will be explained in more detail below.

In some embodiments, an optional progressive wager may be accepted before any cards are dealt, or at least before the at least one participating player is allowed to inspect his or her player cards, as indicated at operation 102A. The optional progressive wager may include, for example, a wager that the player cards of the at least one participating player will include a predetermined winning hand from a group of predetermined winning hands. In some embodiments, the predetermined winning hands include poker ranks such as four aces, four of a kind, a straight flush, and three of a kind. In other embodiments, a participating player may qualify to receive a progressive payout by placing the hand composition wager and receiving one of the predetermined winning hands, without placing a separate progressive wager.

By placing at least one of the play wager, the hand composition wager, and the hand comparison wager, each participating player may qualify to be dealt a partial player hand, as indicated at operation 104. By way of example and not limitation, two player cards may be dealt to each participating player, although any predetermined number of cards may be dealt to each participating player as dictated by game or house rules (e.g., one, three, four, five, six, etc. cards). For example, physical cards that have been randomized (e.g., by manual or automated shuffling) may be distributed sequentially to each participating player, the order of which may be dictated by a set of game or house rules. In yet other embodiments, a partial set of player cards may be dealt to each participating player in a packet of cards. By way of example, each participating player may be dealt a partial player hand including a packet of two player cards. In some embodiments, the player's entire hand may be dealt to each player while the player is only allowed to view the cards constituting the partial player hand. In additional embodiments, digital representations of cards (e.g., images resembling physical cards or characters and symbols) may be displayed on personal display screens 374, 416a, 416b, 416c, 416d, 416e, 416f, 416g, 532a, 532b, 532c, 532d, 532e, or 658 (see FIGS. 5 through 7 and 10) for individual players. In some embodiments, the electronically generated cards may be displayed, for example, to remote players over networks.

The player cards may be dealt face down and may only be visible to the individual player to whom the partial player hand was dealt. It is understood that “face down” may refer to physical playing cards that are in a face down orientation, or digital indications or representations of cards that are not yet revealed to one or more participating players. In other embodiments, one or more of the player cards (e.g., all of the player cards) may be made visible to both the player to whom they were dealt and other participating players, for example, by dealing the player card(s) face up. Further embodiments may involve dealing any predetermined or selected number of cards face up, up to and including all of the cards dealt to each individual player.

Where at least one player card is dealt face down, each participating player may be allowed to inspect the cards in his or her partial player hand, as indicated at operation 106. After inspecting his or her partial player hand, each participating player who placed the play wager may be allowed to fold the play wager or place a raise wager to continue playing the play wager, as indicated at operation 108. The raise wager may be an amount equal to the amount of the play wager. In other embodiments, the raise wager may be unequal to the play wager or a multiple of the play wager. Thus, a raise wager may be accepted from each participating player who decides not to fold the play wager. Each of the participating players may decide whether to fold or continue to play based on his or her partial player hand and whether he or she believes that there is a good chance of achieving a complete player hand with a point total less than a predetermined value. For example, a participating player that has a partial player hand with a relatively low point total (e.g., an ace and a three, or a two and a four) will likely decide to place the raise wager to continue playing, while a participating player with a relatively high scoring partial hand (e.g., a king and a nine, or an eight and a nine) will likely decide to fold to reduce potential losses. In some embodiments with a golf motif, the raise wager may be referred to as a “Back 9” wager. In some embodiments, a previously placed play wager may not be required for the player to place the raise wager.

When a participating player who placed the play wager does not place the raise wager, that participating player's play wager may be collected by the dealer or the house. If the participating player placed only the play wager and subsequently folded the play wager, that participating player will be out of the round of play. Any participating player that has placed the play wager and at least one of the card comparison wager and the card composition wager may remain in the game even though that participating player folded the play wager. In other words, folding the play wager (i.e., not placing the raise wager) does not disqualify a participating player who has placed at least one of the card comparison wager and the card composition wager from participating in the hand comparison game or the hand composition game. In some embodiments, a participating player who placed the progressive wager and does not place the raise wager will not qualify to receive a payout for the progressive wager.

After each participating player has folded or placed the raise wager, a player hand may be completed by the dealer dealing additional cards to each participating player remaining in the round of play, as indicated at operation 110. By way of example and not limitation, two additional player cards may be dealt to each participating player, although any predetermined number of cards may be dealt to each participating player as dictated by game or house rules (e.g., one, three, four, five, six, etc. cards). The additional player cards may be dealt in the same manner as the player cards are dealt to form the partial player hands indicated at operation 104. In some embodiments, the complete player hand may be formed by dealing a same number of additional player cards to each participating player as a number of player cards in the partial player hand. Thus, the complete player hand may include twice as many player cards as the partial player hand. In some embodiments, a complete player hand may include four cards, including two cards dealt at operation 104 to form the partial player hand, and two additional cards dealt at operation 110 to form the complete player hand. As noted above, in some embodiments, each player may be provided the entire player hand and may then be allowed to only view select cards in the hand at designated segments of the game. In such embodiments, operation 110 may include allowing each participating player to inspect his or her complete player hand.

After each participating player remaining in the game has a complete player hand, another set of cards against which each participating player may play (e.g., dealer cards) in at least some of the wagers (e.g., the hand comparison wager) may be dealt, as indicated at operation 112. The dealer cards may be dealt face up. In some embodiments, the dealer receives (e.g., is dealt) the same number of cards as the number of cards in each participating player's complete hand. In some embodiments, the dealer is dealt four cards. In other embodiments, the dealer receives at least one more card than the player to make a best four-card and, or hand with another number of cards.

In some embodiments, the dealer hand may be dealt at the same time as the player hand and the dealer hand may remain face down or otherwise hidden for the view of the players. In such an embodiment, at operation 112, the dealer's hand may be made viewable to the players.

After the set of dealer cards have been dealt or exposed, a point total of the set of dealer cards may be determined, as indicated at operation 114. The point total may be determined by summing the individual rank of each card in the set of dealer cards. Aces may have a point value of one, numerical cards may have a point value of the number designated on the card (e.g., 2's are worth two points, 3's are worth three points, etc.), and face cards may have a point value of ten (10). In some embodiments, the dealer's point total may be determined by adding the value of four cards that form the set of dealer cards.

A point total of each participating player's hand may be determined, as indicated at operation 116. In some embodiments, each participating player has a complete player hand comprising four cards and the point total is determined by summing the value of the four cards that form each participating player's four-card hand.

After determining the point total of each participating player's hand, the play wager and the raise wager may be resolved, as indicated at operation 118. Each participating player may receive a payout for the play wager and the raise wager if the point total of their hand is equal to or lower than a predetermined point total. In some embodiments, a participating player's complete hand includes four cards and the predetermined point total may be twenty-three. Thus, in some embodiments, each participating player may receive a payout for the play wager and the raise wager when the participating player's point total is twenty-three or less. In yet other embodiments, the predetermined point total may be different than twenty-three, such as, for example, twenty, twenty-one, twenty-two, twenty-four, twenty-five, etc., and participating players may receive a payout on the play wager and the raise wager when their complete player hand has a point total equal to or lower than the predetermined point total. In yet other embodiments, the player may win by meeting or exceeding a predetermined point total. In golf-themed games, it is advantageous for the player to compete for the lowest possible score.

In some embodiments, payout for the play wager may be based on predetermined fixed odds (e.g., 1:1, 2:1, 3:1, etc.). In other embodiments, the play wager may pay an even money payout, as long as the hand meets or is below a threshold number. Payout of the play wager may be based on the point total of the participating player's complete player hand according to the payouts shown in Table I.

TABLE I

| Player Point Total | Play Wager Payout |
|---|---|
| 19 through 23 | 1 to 1 |
| 14 through 18 | 1 to 1 |
| 9 through 13 | 1 to 1 |
| 4 through 8 | 1 to 1 |

Although the play wager payout shown in Table I is shown as always having a payout of fixed 1:1 odds (i.e., payouts of even money), the play wager payout is not so limited. For example, the play wager payout may pay increasing odds as the player point total decreases.

The raise wager may be resolved according to a pay table and based on whether each participating player's complete player hand has a point total equal to or lower than the predetermined point total. A raise wager payout may be paid to a qualified participating player according to the raise wager pay table. For example, payout of the raise wager may be based on the point total of each participating player's complete hand, according to the odds shown in Table II.

TABLE II

| Player Point Total | Raise Wager Payout |
|---|---|
| 19 through 23 | 1 to 1 |
| 14 through 18 | 2 to 1 |
| 9 through 13 | 10 to 1 |
| 4 through 8 | 50 to 1 |

In other embodiments, payout of the raise wager may be based on odds different than those shown in Table II. For example, payout of the raise wager may be based on the point total of the participating player's hand according to the odds shown in Table III.

TABLE III

| Player Point Total | Raise Wager Payout |
|---|---|
| 19 through 23 | 1 to 1 |
| 14 through 18 | 2 to 1 |
| 9 through 13 | 10 to 1 |
| 4 through 8 | 75 to 1 |

In yet other embodiments, the payout of the raise wager may be based on odds different than those shown in Table II and Table III. For example, the raise wager may not payout (e.g., and may be a push) where the player point total is relatively close to the predetermined point total. For example, the payout of the raise wager may be based on the point total of the participating player's complete player hand according to the odds shown in Table IV.

TABLE IV

| Player Point Total | Raise Wager Payout |
|---|---|
| 19 through 23 | 0 (push) |
| 14 through 18 | 2 to 1 |
| 9 through 13 | 10 to 1 |
| 4 through 8 | 50 to 1 |

In yet other embodiments, the raise wager may be paid out based on different player point totals than those presented in Table II through Table IV above. For example, the raise wager payout may be based on player point totals ranging from between twenty and twenty-four, from between nineteen and twenty-five, or from between nineteen and twenty-four, according to the odds shown in Table V, Table VI, or Table VII below.

TABLE V

| Player Point Total | Raise Wager Payout |
|---|---|
| 20 through 24 | 0 (push) |
| 14 through 19 | 2 to 1 |
| 9 through 13 | 10 to 1 |
| 4 through 8 | 50 to 1 |

TABLE VI

| Player Point Total | Raise Wager Payout |
|---|---|
| 19 through 25 | 0 (push) |
| 13 through 18 | 2 to 1 |
| 9 through 12 | 10 to 1 |
| 4 through 8 | 50 to 1 |

TABLE VII

| Player Point Total | Raise Wager Payout |
|---|---|
| 19 through 24 | 1 to 1 |
| 14 through 18 | 2 to 1 |
| 9 through 13 | 5 to 1 |
| 4 through 8 | 25 to 1 |

In some embodiments, a bonus payout may be paid to each participating player who placed the play wager and the raise wager based on the number of cards having the same suit in the player's complete player hand. For example, participating players who placed the play wager and the raise wager may receive a bonus payout where the participating player's complete player hand includes three or more cards having the same suit (e.g., a flush). The bonus payout may increase for an increasing number of cards in the participating player's hand having the same suit (e.g., a hand with four cards of the same suit may receive a higher payout than a hand of three cards of the same suit). For example, each participating player may be paid an increased payout on at least one of the play wager and the raise wager where the participating player has a complete player hand including at least three cards of the same suit. The bonus payout may be in addition to any payout based on the participated player's point total as described above with reference to Table I through Table VII. Such a payout may be referred to as an “automatic” bonus because no additional bets are required to qualify for a payout.

A participating player who placed the play wager and the raise wager may receive the bonus payout although the participating player may not receive a payout on the play wager or the raise wager. By way of non-limiting example, a participating player with a king, jack, eight, and nine, all of the same suit, may not receive a payout for the play wager or the raise wager, but may qualify to receive the bonus payout. Although the bonus payout has been described as being tied to the play wager and the raise wager, the bonus payout is not so limited. For example, a participating player with a complete player hand including three or more cards of the same suit may qualify for the bonus payout by placing at least one of the hand comparison wager and the hand composition wager.

After determining the point total of the dealer's set of cards and each of the participating player's set of cards, as indicated at operations 114 and 116, respectively, the hand comparison wager may be resolved, as indicated at operation 120. The hand comparison wager may be resolved based on a comparison of a point total of each participating player's complete player hand to the point total of the dealer's hand. Participating players with a complete player hand having a lower point total than the dealer's hand may receive a payout on the hand comparison wager according to predetermined fixed odds (e.g., 1:1, 2:1, 3:1, etc.). In other embodiments, payout of the hand comparison wager may be determined based on a pay table. In some embodiments, the hand comparison wager pays out odds of 1:1 (i.e., even money).

If the player's point total is equal to the point total of the dealer, the player may not receive the hand comparison wager payout. Accordingly, in some embodiments, the player receives the hand comparison wager payout only when the player's point total is less than the dealer's point total. Ties push on the hand comparison wager in some embodiments.

After resolving the hand comparison wager, the hand composition wager may be resolved, as indicated at operation 122. The hand composition wager may be resolved based on a number of aces held by each participating player. In other embodiments, another card in the deck (or decks) may be designated as a winning card. For example, the deck may contain one or two jokers, and jokers may be designated as a winning outcome on the hand composition wager. In other examples, three's (3's) or other standard cards are designated winning cards. Participating players who placed the hand composition wager and who have a predetermined qualifying hand may receive a payout for the hand composition wager. The hand composition wager payout may be paid to qualifying participating players according to a pay table. For example, the hand composition wager payout may be based on the number of aces in the player's complete player hand according to the odds shown in Table VIII.

TABLE VIII

| Number of Aces in | Hand Composition |
|---|---|
| Complete Player Hand | Wager Payout |
| 1 | 2 to 1 |
| 2 | 5 to 1 |
| 3 | 50 to 1 |
| 4 | 1,000 to 1 |

In yet other embodiments, the hand composition wager payout may be based on the number of aces in the player's complete player hand according to the odds shown in Table IX below.

TABLE IX

| Number of Aces in | Hand Composition |
|---|---|
| Complete Player Hand | Wager Payout |
| 1 | 2 to 1 |
| 2 | 6 to 1 |
| 3 | 50 to 1 |
| 4 | 1,000 to 1 |

Participating players may receive the hand composition wager payout whether or not the participating player placed the play wager and the raise wager and independent of the outcome of the play wager and the raise wager. For example, a participating player may place the play wager and the hand composition wager, forfeit the play wager by not placing the raise wager, and subsequently receive a payout for the hand composition wager by receiving at least one ace in the complete player hand.

Although the hand composition wager has been described as being based on a number of aces held in the participating player's complete player hand, the hand composition wager may be based on a number of cards having a particular point value in the participating player's hand. By way of example, the hand composition wager may be based on the number of cards with a point value of two in the participating player's complete player hand.

After the complete player hand has been formed, any progressive wagers may be resolved, as indicated at operation 124. The progressive wager may be resolved based on one or more predetermined qualifying hands. Participating players who placed the optional progressive wager and who have a qualifying complete player hand may receive a payout for the progressive wager. Qualifying player hands may include hands of a particular poker rank, such as four aces, four of a kind, straight flush, and three of a kind. In some embodiments, a participating player who does not place the raise wager may not qualify to receive a payout on the progressive wager although the participating player holds a qualifying hand.

The top payout on the progressive wager may be a progressive payout (e.g., a progressive jackpot). In some embodiments, each time a participating player places a progressive wager, a portion of the progressive wager may be apportioned to a progressive pool to be paid out to a participating player who receives a complete player hand including a predetermined progressive jackpot condition as described in, for example, U.S. Pat. No. 5,078,405 to Jones, issued Jan. 7, 1992, which is incorporated herein in its entirety by this reference. The progressive payout may be seeded by the house or gaming establishment, such as with, for example, a $1,000 seed or a $5,000 seed. Each time the progressive payout is won by a participating player, the house or gaming establishment may reset the value of the progressive payout with the seed amount.

In some embodiments, a progressive jackpot is paid out to a participating player who places the optional progressive wager and holds a complete player hand including four aces.

A progressive wager payout may be paid to qualifying participating players according to a pay table. For example, the progressive wager payout may be based on predetermined poker ranks according to the odds shown in Table X.

TABLE X

| Complete Player Hand | Progressive |
|---|---|
| Poker Rank | Wager Payout |
| Three of a Kind | 9 to 1 |
| Straight Flush | 100 to 1 |
| Four of a Kind | 300 to 1 |
| Four Aces | Progressive Payout |

In yet other embodiments, a participating player may qualify to receive a progressive payout without placing the progressive wager. For example, each time a participating player places a hand composition wager, a portion of the hand composition wager may be apportioned to a progressive pool to be paid out to a participating player who obtains a complete player hand including a predetermined progressive jackpot condition (e.g., four aces). In other embodiments, the progressive wager may instead be a jackpot wager, and the payout may not include a progressive payout and instead may be based on predetermined poker ranks according to the fixed odds shown in Table XI.

TABLE XI

| Complete Player Hand | Progressive |
|---|---|
| Poker Rank | Wager Payout |
| Three of a Kind | 9 to 1 |
| Straight Flush | 100 to 1 |
| Four of a Kind | 300 to 1 |
| Four Aces | 1000 to 1 |

In embodiments in which participating players may automatically qualify to receive a progressive wager payout by placing the hand composition wager, a participating player who receives a complete player hand including three aces may receive the payout shown in Table VIII and Table IX for a complete player hand including three aces (e.g., 50 to 1), rather than the payout shown in Table XI for a complete player hand including three of a kind (e.g., 9 to 1).

In some embodiments, each participating player may qualify to receive an envy payout. By way of example and not limitation, each participating player who placed the hand composition wager or progressive wager may qualify to receive the envy payout. Participating players who placed the hand composition wager may receive the envy payout when another participating player receives a winning outcome in the hand composition wager or progressive wager. The envy payout may be awarded to participating players who placed the hand composition wager or progressive wager but who did not receive a higher payout in the hand composition wager or progressive wager relative to the other participating players. For example, if the highest poker rank obtained by a participating player in a round of play is a four of a kind, qualifying participating players (e.g., participating players who placed the hand composition wager or progressive wager) who did not receive a hand with a poker rank of four of a kind or higher may receive the envy payout. In some embodiments, the envy payout may be based on the poker ranking of the participating player who received the highest payout in the hand composition wager or progressive wager, according to the odds shown in Table XII.

TABLE XII

| Poker Rank of Best | |
|---|---|
| Complete Player Hand | Envy Payout |
| Three of a Kind | None |
| Straight Flush | $1 |
| Four of a Kind | $10 |
| Four Aces | $100 |

After the play wager, the raise wager, the hand comparison wager, the hand composition wager, and optional progressive wagers have been resolved and winning payouts paid to any qualifying participating player(s), any losing play wager, raise wager, hand comparison wager, hand composition wager, and progressive wager may be retained by the casino or other gaming establishment, as indicated at operation 126.

In some embodiments, an advantage (e.g., a so-called “house edge”) may be provided to the casino or other establishment. For example, the advantage may be provided to the casino or other establishment by adjusting payout odds in favor of the casino or other establishment, and/or by allowing the casino or other establishment to withhold a portion of every wager, such as by taking a rake (i.e., a certain percentage) of each play wager.

Although the method 100 of administering a wagering game illustrated in FIG. 1 has been described as following a particular sequence, the present disclosure is not so limited. In some embodiments, the operation 118 of resolving the play wager and the raise wager may be performed before the operation 116 of determining a point total of each participating player's complete player hand. In other embodiments, the operation 124 of resolving the progressive wager may be performed at any time after operation 110 of dealing two additional cards to each participating player to form a complete player hand. In yet other embodiments, operation 118 of resolving the play wager and the raise wager, operation 120 of resolving the hand comparison wager, and operation 122 of resolving the hand composition wager may be performed in any order. By way of non-limiting example, the hand comparison wager and the hand composition wager may be resolved before resolving the play wager and the raise wager. Thus, any of the play wager, the raise wager, the hand comparison wager, the hand composition wager, and the optional progressive wager may be resolved at any convenient time during a game round after the wagers have been accepted from at least one participating player.

Various platforms are contemplated that are suitable for implementation of embodiments of wagering games according to this disclosure. For example, embodiments of wagering games may be implemented as live table games with an in-person dealer, electronic gaming machines, partially or fully automated table games, and partially or fully automated, network-administered games (e.g., Internet games) wherein game results may be produced utilizing a processor or a live video feed of a dealer administering a game from a remote studio. By way of further example, wagering games may be implemented on gaming tables, which may include physical game pieces, such as a table cover in the marked areas, referred to as a “layout”, physical cards and physical chips, and may include a live dealer and a shuffler or shoe. More specifically, a live dealer may deal physical cards, evaluate hands, accept wagers, accept player elections, issue payouts, retain wagers, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

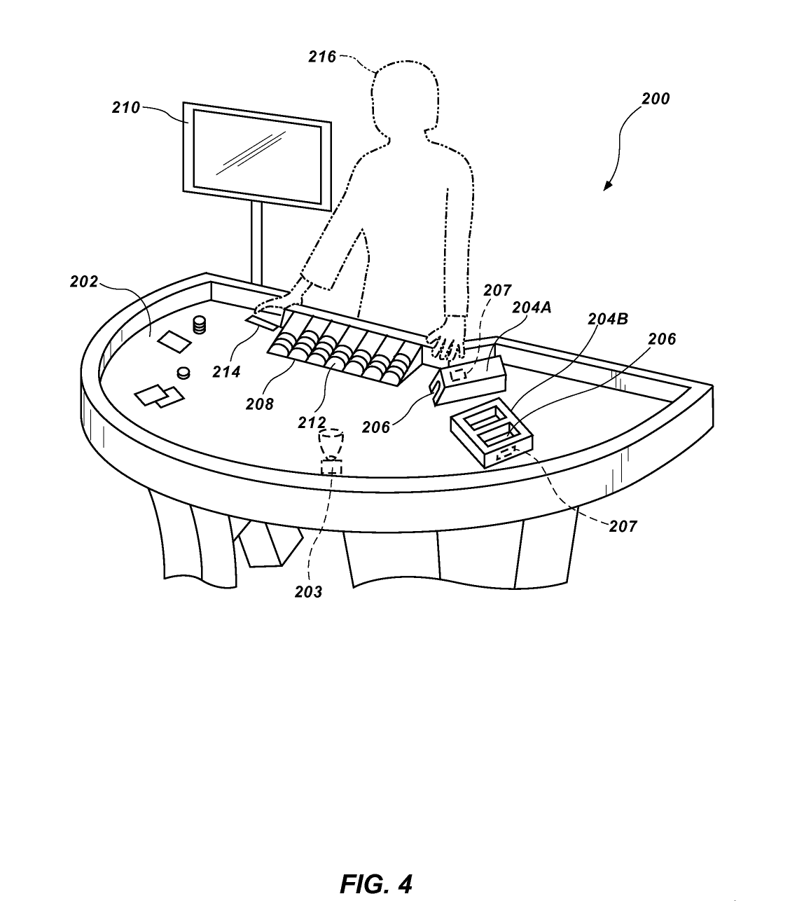

In some embodiments, the wagering game may include a golf motif. The wagering game may be administered by an electronic gaming machine, partially or fully automated table games, and partially or fully automated, network-administered games (e.g., Internet games) wherein game results may be produced utilizing a processor or a live video feed of a dealer administering a game from a remote studio. In such embodiments, electronic representations of the wagering game on at least one display screen 210, 374, 416a, 416b, 416c, 416d, 416e, 416f, 416g, 430, 532a, 523b, 532c, 532d, 532e, 560, 564, or 658 (see FIGS. 4 through 7 and 10) may include animations that relate to play of the wagering game. In some embodiments, the display screen may be a common display viewable by all participating players and in other embodiments, the display screens may be individualized and viewable by a single participating player associated with the display screen. The display screens may be configured to display animations responsive to outcomes of the wagering game for each participating player. For example, the display screens may be configured to display a graphic or video such as an animation of a player hitting a golf ball from one hole to another or onto a fairway, green, or hole when the participating player receives a winning outcome on at least one of the wagers and may be configured to display an animation of a player hitting a golf ball from a tee box to an obstruction such as a bunker, a sand trap, a water hazard, or other obstruction when the participating player receives a losing outcome for at least one of the wagers. In some embodiments, an animated animal (e.g., a gopher) may be named to give participating players a sense of either competition or friendship with the animated gopher. The display screens may be configured to display electronic representations of the gopher laughing or taunting a participating player for each wager that the participating player places and loses or may be configured to cheer for and encourage the participating player for each wager the participating player places and receives a winning outcome. The gopher may be configured to take or move a participating player's golf ball or otherwise interfere with a player's golf ball. Such animations may induce more interest and excitement from participating players.

Although the wagering game has been described as involving a single player placing one or more wagers and competing against a predetermined pay table for the play wager, raise wager, and hand composition wager, and against the dealer for the hand comparison wager, the wagering game is not so limited. For example, the wagering game may be played with more than one participating player. In some embodiments, the game may be played as a tournament style game. By way of non-limiting example, a group of participating players may play as a team against the predetermined pay tables, the dealer, or both. In some embodiments, a complete player hand of a participating player with the lowest point total may be shared by all participating players on a team and all wagers may be settled based on the complete player hand with the lowest point total. In yet other embodiments, a tournament may include playing multiple rounds of the wagering game (e.g., such as nine rounds or eighteen rounds, such as where the wagering game includes a golf motif). In such embodiments, participating players may place a wager to participate in the tournament. Participating players with the lowest point total in each round may advance to the next round whereas the participating player with the highest point total may not qualify to advance to the next round of play.

FIG. 2, an exemplary diagram of a playing surface 150 (also referred to as “gaming table 150”) having one or more player positions 152 and a dealer card position 154 for implementation of the wagering game within the scope of the disclosure is shown. Such an implementation may include a felt layout on a physical gaming table or an electronic representation of a felt layout on a video display screen (see, e.g., FIGS. 5 through 7 and 10) for each participating player position 152. The playing surface 150 may include images related to the motif of the wagering game. For example, the playing surface 150 may include images of flags, holes, golf balls, gophers, etc. where the wagering game includes a golf motif. The images may be printed onto a cloth surface, may be woven into the cloth surface, or may be projected onto the cloth surface from above or below the cloth surface. The play surface may also be formed of another material such as a rigid plastic, wood, metal or other composite material.

The playing surface 150 may define a plurality of the participating player positions 152 within which the activity (e.g., wagering and card dealing) for individual players may take place. The dealer card position 154 may be a position where dealer cards may be dealt. For example, the dealer card position 154 may include an area where a number of cards of a dealer hand may be dealt and positioned, such as an area sufficiently large to position four cards side by side or stacked in columns and rows.

As depicted, one or more of the participating player positions 152 and the dealer card position 154 may include one or more indicia related to the wagering game. For example, each of the participating player positions 152 and the dealer card position 154 may include a hand composition wager pay table 160 indicating the odds associated with the payouts for the hand composition wager and a raise wager pay table 162 indicating the odds associated with the payouts for the raise wager. Although the playing surface 150 in FIG. 2 shows six player positions 152, the number of player positions 152 is not so limited. For example, the playing surface 152 may include any number of player positions 152, such as any number between two and ten, for example.

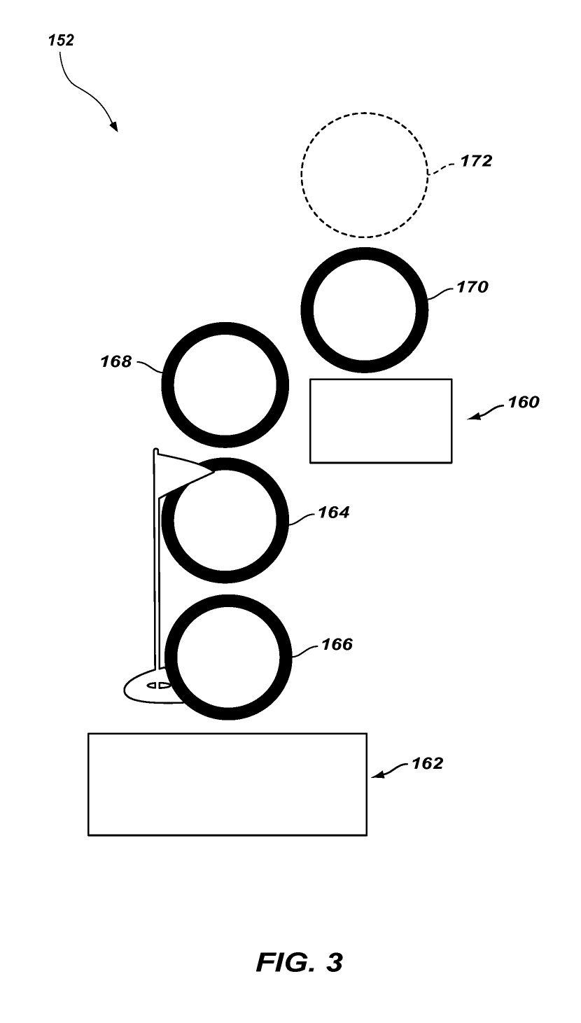

Referring to FIG. 3 an enlarged diagram of one of the player positions 152 of the playing surface 150 of FIG. 2 is shown. Each player position 152 may include a play wager region 164 within which money or representations of money may be placed or displayed (e.g., physically positioned or digitally displayed) in a designated betting area when the play wager is accepted. Each player position 152 may also include a raise wager region 166 within which a raise wager may be placed when the participating player decides not to fold the play wager and the raise wager is accepted. In some embodiments, the raise wager region 166 may be positioned proximate to the raise wager pay table 162, which may display the odds associated with the payout of the raise wager. Each player position 152 may also include a hand comparison wager region 168 within which a hand comparison wager may be placed or displayed when the hand comparison wager is accepted. Each player position 152 may also include a hand composition wager region 170 within which a hand composition wager may be placed or displayed when the hand composition wager is accepted. In some embodiments, the hand composition wager region 170 may be positioned proximate to the hand composition wager pay table 160, which may display the odds associated with the payout of the hand composition wager. In yet other embodiments, each player position may, optionally, include a progressive wager region 172 within which an optional progressive wager may be placed or displayed when the progressive wager is accepted. The progressive wager region may include an electronic bet sensor (not shown) such as the bet sensor disclosed in U.S. Pat. No. 7,367,884. The content of this patent is incorporated by reference in its entirety. In some embodiments, each of the play wager region 164, the raise wager region 166, the hand comparison wager region 168, the hand composition wager region 170, and the optional progressive wager region 172 may be uniquely identified. For example, the play wager region 164 may be identified with words such as “Front 9,” the raise wager region 166 may be identified with words such as “Back 9,” the hand comparison wager region 168 may be identified with words such as “Skins,” the hand composition wager region 170 may be identified with words such as “Gopher Bet,” and the progressive wager region 172 may be identified with words such as “Progressive” or “Jackpot.” In some embodiments, the raise wager pay table 162 may include terms such as “Albatross Bonus” for the highest payout, “Eagle Bonus” for the next highest payout, “Birdie Bonus” for the next highest payout, and “Par” for the lowest payout.

In some embodiments, one or more of the wager regions may include sensors to automatically sense the presence and/or the value of a wager.

With combined reference to FIGS. 2 and 3, a specific embodiment of an implementation of the wagering game described in connection with FIG. 1 is presented. Play of a round of the wagering game may begin by accepting at least one of a play wager, a hand comparison wager, and a hand composition wager from each participating player position 152.

In some embodiments, the play wager is mandatory. An optional progressive wager may be accepted from at least one participating player position 152 in addition to or alternatively from the one or more of the other wagers. For example, play of a round of the game may begin by accepting a play wager from one participating player position 152, accepting a hand comparison wager from another participating player position 152, and receiving a play wager, a hand comparison wager, a hand composition wager, and a progressive wager from at least another participating player position 152. A play wager may be accepted from each participating player position 152 by receiving money or representations of money (e.g., chips) in the play wager region 164. A hand comparison wager may be accepted by receiving money or representations of money in the hand comparison wager region 168. A hand composition wager may be accepted by receiving money or representations of money in the hand composition wager region 170. A progressive wager may be accepted by receiving money or representations of money in the progressive wager region 172. After at least one of the optional play wager, the hand comparison wager, and the hand composition wager have been accepted by placing the wagers in the respective positions, a number of player cards (e.g., two player cards, three player cards, or more or less) may be dealt to player card positions (e.g., below, above, or on the player position 152 in the perspective of FIG. 3) of each participating player position 152 to form a partial player hand. In some embodiments, two player cards may be dealt face down to each participating player position 152. In some embodiments, the player cards may be delivered from a shuffler. The dealer may deliver the player cards to participating players in a clockwise manner, beginning at the dealer's left. By way of example, the dealer may deliver two cards to each participating player in two-card sets, beginning at a participating player position 152 at the dealer's left and may proceed to deliver two cards to each participating player position 152 in a clockwise manner until all participating player positions 152 have received two player cards. In other embodiments, the dealer may deal the cards to each participating player position 152 one at a time.

After allowing each participating player to inspect his or her set of player cards, referring to FIGS. 1 through 3, the dealer may receive an election from each participating player who placed the play wager to fold and surrender any outstanding play wager or may receive a raise wager from the participating player. For example, the dealer may receive an indication from the player that he or she wishes to fold the play wager by observing the player passing his or her respective player hand, face down, on the playing surface 150 above the player's participating player position 152 and toward the dealer. If a participating player decides to fold the play wager by not placing a raise wager and that participating player did not place either of the hand comparison wager or the hand composition wager, that participating player is out for the round of play and the dealer may discard that player's cards in a discard rack. If a participating player folds the play wager, but has placed at least one of the hand comparison wager and the hand composition wager, the participating player may remain in the round of play until completion of the hand comparison wager and the hand composition wager. If a participating player placed the hand comparison wager and folds the play wager, that participating player's cards may be tucked under the hand comparison wager at the hand comparison wager region 168. If a participating player placed the hand composition wager, but folds the play wager and does not place the hand comparison wager, that participating player's cards may be tucked under the hand composition wager at the hand composition wager region 170.

The dealer may accept a raise wager placed by a participating player in the raise wager region 166 if a participating player decides not to fold the play wager. In some embodiments, the allowable amount of the raise wager may be equal to the play wager. In other embodiments, the raise wager may be a specific multiple of the play wager, may be selected from a group of allowable multiples of the play wager, or may be any amount with or without an upper and/or lower limit, but within table limits. If a participating player places the raise wager, the participating player's cards may be tucked under the raise wager in the raise wager region 166.

After the dealer has received fold or continue play elections (e.g., has either not received the raise wager or has received the raise wager) from the participating players, the dealer may deal additional cards to each remaining participating player to form a complete player hand. Remaining participating players may include any participating player who placed the play wager and the raise wager (e.g., did not fold the play wager) and any participating player who placed at least one of the hand comparison wager and the hand composition wager, regardless of whether or not that participating player placed the play wager or the raise wager. The additional cards may be dealt to each remaining participating player in a manner substantially similar to the manner in which the partial player hands were dealt to the participating players. For example, the additional cards may be dealt from a shuffler and delivered to remaining participating player positions 152 located at the dealer's left and in a clockwise manner until all remaining participating player positions 152 have received a complete player hand. The additional cards may be delivered to and positioned on the playing surface 150 at each remaining participating player's player position 152 at the same location as the two cards that form the partial player hand for each participating player. For example, if a participating player's two cards are tucked under the hand comparison wager in the hand comparison wager region 168, the additional two cards may be delivered to and positioned at the hand comparison wager region 168.

After completing player hand of each remaining participating player, the dealer may deal a dealer hand (e.g., a dealer set of cards) to the dealer at the dealer card position 154. In some embodiments, each card in the dealer set of cards is dealt face up. The dealer set of cards may include the same number of cards as a number of cards in a complete player hand. Thus, in some embodiments, the dealer set of cards and the complete player hand may include four cards. In other embodiments, the dealer may be dealt one more card than each player to make a best hand, such as a best four-card and when the dealer received five cards.

After the set of dealer playing cards has been delivered to the dealer card position 154 and exposed, a point total of the dealer hand may be determined. In some embodiments, the dealer may announce his or her point total as each card is delivered to the dealer card position 154. The point total may be determined based on the value of individual cards held by the dealer wherein aces have a value of one, cards with numerical designations have the value of the number displayed on the card, and face cards have a value of ten.

After determining the point total of the dealer's cards, a point total of each participating player's complete player hand may be determined by summing the values of the cards that make up each participating player's complete player hand.

The dealer may reveal any face down player cards and determine a point total for each participating player. The dealer may resolve the play wager and the raise wager by paying a payout to a participating player who placed the play wager and the raise wager and who has a point total equal to or lower than a predetermined winning point total. In some embodiments, the predetermined point total is twenty-three. A participating player who placed the play wager and the raise wager with a point total less than twenty-three may receive a play wager payout in other embodiments. The play wager may be resolved according to, for example, predetermined odds (e.g., fixed odds payout, such as, for example, 1:1).

The play wager payout may be paid to any participating player who has elected to make the play wager prior to receiving and/or inspecting his or her player cards, placed the raise wager, and who holds a qualifying complete player hand. For any participating player that does not hold a complete player hand with a point total equal to or lower than the predetermined point total (e.g., twenty-three), the participating player's play wager may be retained by the dealer and/or house.

The raise wager may be resolved according to, for example, an odds payout based on a pay table (see, e.g., Table II through Table VII above). A participating player who receives a payout for the play wager may also receive a payout for the raise wager. A participating player may receive increasing payouts for the raise wager for decreasing point totals. In other words, the lower the point total of a participating player's complete player hand, the higher the payout for the raise wager that the participating player may receive. For any participating player that does not hold a complete player hand with a point total at or below the predetermined point total (e.g., twenty-three), any portion of that participating player's play wager and raise wager than remains in play may be retained by the dealer and/or house.

The hand comparison wager may be resolved at any time after determining a point total of the dealer's set of cards and a point total of each participating player's complete player hand. The hand comparison wager may be resolved by comparing the point total of a participating player's complete player hand to the point total of the set of dealer cards. Participating players with a point total lower than the dealer's point total may qualify to receive a payout for the hand comparison wager. If the participating player's point total is equal to or greater than the dealer's point total, the player may not qualify to receive the hand comparison wager payout. By way of example and not limitation, the hand comparison wager may be resolved, and a fixed odds payout paid to the participating player, according to, for example, predetermined odds (e.g., fixed odds payout, such as, for example 1:1).

The hand comparison wager may be paid to any participating player who has elected to make the hand comparison wager prior to receiving and/or inspecting his or her player cards and who holds a qualifying complete player hand. For any participating player that does not hold a complete player hand with a lower point total than the dealer's hand, that participating player's hand comparison wager may be retained by the dealer and/or house.

The hand composition wager may be resolved at any time after dealing each participating player his or her complete player hand. The hand composition wager may be resolved by determining a number of aces in a participating player's complete player hand. A participating player who placed the hand composition wager and who has at least one ace in his or her complete player hand may qualify to receive a payout for the hand composition wager. The hand composition wager payout may increase as the number of aces in the participating player's complete player hand increases. By way of example and not limitation, the hand composition wager may be resolved, and a fixed odds payout paid, according to a bonus pay table (see, e.g., Table VIII and Table IX above). In other embodiments, when the player holds one or more of another designated card such as a joker, a 2 or a 5, for example, the player wins the hand composition bet.

The hand composition wager may be paid to any participating player who has elected to make the hand composition wager prior to receiving and/or inspecting his or her player cards and who holds a qualifying complete player hand according to the hand composition wager pay table. For any participating player that does not hold a complete player hand with at least one ace or other predetermined card, that participating player's hand composition wager may be retained by the dealer and/or house.

In some embodiments, participating players who placed the hand composition wager may qualify to receive a payout based on a poker ranking of that participating player's complete player hand (see, e.g., Table X and Table XI above). A payout may be paid to each participating player who placed the hand composition wager and who receives a qualifying complete player hand. In some embodiments, a participating player who placed the hand composition wager and who receives a highest ranking complete player hand (e.g., four aces) may receive a progressive payout.

The optional progressive (or jackpot) wager may be resolved at any time after each participating player's complete player revealed. A participating player who placed the optional progressive (or jackpot) wager and who has a complete player hand including a predetermined poker rank may qualify to receive a payout for the progressive wager (or odds payout). By way of example and not limitation, the progressive wager may be resolved according to a progressive wager pay table (see e.g., Table XI above). For any participating player that does not hold a complete player hand including one of the predetermined poker ranks, that participating player's progressive wager may be retained by the dealer and/or house.

In some embodiments, participating players who placed the hand composition or progressive wager may qualify to receive an envy payout when another participating player who placed the hand composition or progressive wager receives a winning outcome in the hand composition or progressive wager (see, e.g., Table XII above). A payout may be paid to each participating player who qualifies to receive the envy payout.

After any remaining portions of the play wager, the raise wager, the hand comparison wager, the hand composition wager, and the progressive (or jackpot) wager are resolved and payouts (if any) are paid and/or wagers collected and retained, the player cards and dealer cards may be collected and the game round ended.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout design specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, non-limiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, pay tables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time or more than one at a time. More specifically, the card-handling device 204 may be, for example, a mechanized, automatic shoe (i.e., a shoe including an internal, electromechanical, self-acting mechanism to handle card movement within the shoe, present cards for withdrawal, and optionally identify cards) or a non-mechanized shoe. Such a card-handling device 204A may include, for example, a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosures of which is incorporated herein in its entirety by this reference.

The card-handling device 204B may be, for example, a shuffler configured to reorder physical cards 206 from one or more decks of playing cards and present randomized cards 206 for use in the wagering game. Such a card-handling device 204B may include, for example, a housing, a shuffling mechanism configured to shuffle cards, and card inputs and outputs (e.g., trays). More specifically, the card-handling device 204B may be, for example, a batch shuffler, a continuous shuffler, or a combination shuffler and shoe. Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. Shufflers such as the devices disclosed in the '574 Patent may include card recognition capability and may internally, or in an output tray, form randomly ordered hands of a known composition within the shuffler. Additionally, game rules may also be programmed within the shuffler such that the processor of the shuffler is capable of identifying a winning wager prior to automatic delivery of cards for resolving the wager into a shoe or other card delivery. As a specific, non-limiting example, the card-handling device 204 may be a combination shuffler and shoe in which the output for the shuffler is a shoe.

In some embodiments, the card-handling device 204 may be configured and programmed to administer at least a portion of a hand of cards for a wagering game being played utilizing the card-handling device 204. For example, the card-handling device 204 may be programmed and configured to randomize a set of cards and present one or more cards for use according to game rules. More specifically, the card-handling device 204 may be programmed and configured to, for example, randomize a set of cards including one or more 52-card decks of standard playing cards and, optionally, any specialty cards (e.g., a cut card, bonus cards, wild cards, or other specialty cards). In some embodiments, the card-handling device 204 may present individual cards, one at a time, for withdrawal from the card-handling device 204. In other embodiments, the card-handling device 204 may present packets of cards representing a subset of the complete set of cards handled by the card-handling device 204 (e.g., individual hands, one hand at a time, a group of hands, a partial hand or hands and then additional cards as needed to complete the hand or hands, a hand or hands and any burn or specialty cards to be used in the same round as the hand or hands) for withdrawal from the card-handling device 204. In some such embodiments, the card-handling device 204 may accept dealer input, such as, for example, a number of replacement cards for discarded cards, a number of hit cards to add, or a number of partial hands to be completed. In other such embodiments, the device may accept a dealer input from a menu of game options indicating a game selection, which will select programming to deliver the requisite number of cards to the game, depending on the game rules. The game rules may be programmed into the memory of the card-handling device 204. As specific, non-limiting examples, the card-handling device 204 may present a packet of cards representing a single hand or a packet of cards representing a group of hands, each hand including four cards, as described previously in connection with FIG. 1. In other embodiments, the card-handling device 204 may present cards one at a time for withdrawal, a dealer drawing, for example two, or four to deal to each player, as described previously in connection with FIG. 1.

Suitable shufflers may be configured to deliver packets of cards forming partial hands, and then in an additional dealing round or rounds, deliver additional cards to complete the hand, as described in U.S. Pat. No. 8,702,100, the content of which is incorporated by reference in its entirety.

Packets of cards used as player hands, partial player hands, dealer hands, partial dealer hands, community cards, or other card groups may be formed internally within the shuffler, such as within an internal compartment, as described in the '574 patent, or may be formed in an output tray of the shuffler. For example, U.S. Pat. No. 6,698,756, issued Mar. 2, 2004, to Baker et al. describes such a device. Other suitable shufflers include U.S. Pat. No. 6,267,248, issued Jul. 31, 2001, to Johnson et al, which describes a shuffler that can form a random set of cards, such as a deck or multiple decks, U.S. Pat. No. 7,766,332, issued Aug. 3, 2010, to Grauzer et al., which describes forming groups of player and/or dealer cards in compartments within a shuffler; U.S. Patent App. Pub. No. 2014/0027979, published Jan. 30, 2014, to Stasson et al., which shows an alternate method of randomly forming a set of cards in a shuffler such as one or more decks of cards; and U.S. Pat. No. 6,588,750, issued Jul. 8, 2003, to Grauzer et al., which shows a device for randomizing a set of cards using a gripping, lifting and insertion sequence. The disclosure of each of the foregoing documents is incorporated herein in its entirety by this reference.

In some embodiments, the card-handling device 204 may employ a random number generator device to determine card order, such as, for example, a final card order or an order of insertion of cards into a compartment configured to form a packet of cards. The compartments may be sequentially numbered, and a random number assigned to each compartment number prior to delivery of the first card. In other embodiments, the random number generator may select a location in the stack of cards to separate the stack into two sub-stacks, creating an insertion point within the stack at a random location. The next card may be inserted into the insertion point. In yet other embodiments, the random number generator may randomly select a location in a stack to randomly remove cards by activating an ejector.

Other functions of the random number generator may be game-specific. For example, a random number generator internal or external to the shuffler may be used to randomly select a player to receive a first packet of cards, including a hand or a portion of a hand, according to the game rules. In other examples, the random number generator may select a game position to receive an extra card, one less card, or a random number of cards, depending upon the specific rules of the game.

Regardless of whether the random number generator is hardware or software, it may be used to implement specific game administration methods of the present disclosure. A suitable device employing random number generation for card management and randomization is marketed under the name MD3® by Bally Gaming, Inc. of Las Vegas, Nev. Aspects of this device are described in U.S. Pat. No. 8,579,289, issued Nov. 12, 2013, to Rynda et al., and the shuffling mechanism is fully described in U.S. Pat. No. 7,677,565, issued Mar. 16, 2010, to Grauzer et al., the disclosure of each of which is incorporated herein in its entirety by this reference.

The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, promotional cards, no value cards, etc. In yet other embodiments, other types of decks of cards may be used, such as a deck of Spanish playing cards. The shuffler may also be configured to handle and dispense security cards, such as cut cards.

In some embodiments, the card-handling device 204 may include an electronic display 207 for displaying information related to the wagering game being administered. For example, the electronic display 207 may display a menu of game options, the name of the game selected, the number of cards per hand to be dispensed, acceptable amounts for wagers (e.g., maximums and minimums), numbers of cards to be dealt to recipients, locations of particular recipients for particular cards, winning and losing wagers, pay tables, winning hands, losing hands, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. Cards used in games of this disclosure may be, for example, standard playing cards from one or more decks, each deck having cards of four suits (clubs, hearts, diamonds, and spades) and of rankings ace, king, queen, jack, and ten through two in descending order. As a more specific example, six, seven, or eight standard decks of such cards may be intermixed. Typically, six or eight decks of 52 standard playing cards each may be intermixed and formed into a set. A suitable device employing random number generation for card management and randomization is marketed under the name MD3® by Bally Gaming, Inc. of Las Vegas, Nev. Aspects of this device are described in U.S. Pat. No. 8,579,289, issued Nov. 12, 2013, to Rynda et al., and the shuffling mechanism is fully described in U.S. Pat. No. 7,677,565, issued Mar. 16, 2010, to Grauzer et al., the disclosure of each of which is incorporated herein in its entirety by this reference. After shuffling, the randomized set may be transferred into another portion of the card-handling device 204B or another card-handling device 204A altogether, such as a mechanized shoe capable of reading card rank and suit. More specifically, the shoe disclosed in, for example, U.S. Pat. No. 8,511,684, issued Aug. 20, 2013, to Grauzer et al., the disclosure of which is incorporated herein in its entirety by this reference, may be used to automatically dispense one or more cards at a time from the randomized set.

In some embodiments, randomization of the cards may occur off-site, such as, for example, by purchasing the set of cards in its randomized form and introducing the randomized set of cards into the card-handling device 204 for delivery. In other embodiments, the cards may be randomized on-site before, during, or both before and during administration of the wagering game. For example, the set of cards may be randomized in a batch shuffler and introduced into a shoe for dealing or the set of cards may be continuously shuffled by a continuous shuffler, introduced in sets into a shoe integral to the continuous shuffler, withdrawn from the shoe and used for game play, and finally reintroduced into the continuous shuffler. After randomization, the set of cards may be transferred into another portion of the card-handling device 204 or another card-handling device 204 altogether, such as a mechanized shoe capable of reading card rank and suit.

In some embodiments, the wagering game may be hand-pitched. For example, a live, in-person dealer may deal cards from a set not located in a card-handling device. In some such embodiments, the dealer may also randomize the cards by hand-shuffling the set of cards.

As a specific, non-limiting example, the card-handling device 204 may comprise an automatic shuffler that is configured to provide packets of cards (e.g., two cards making the partial player hand or four cards making the complete dealer hand) to the dealer. In other embodiments, the card-handling device 204 may comprise an automatic or a manual shuffler configured to deliver one card at a time to the dealer to distribute to the dealer and participating players.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the drop box 214 and transfer physical wagering elements 212 to the player. The dealer 216 may accept one or more initial wagers (e.g., antes and other wagers) from the player, which may be reflected by the dealer 216 permitting the player to place one or more wagering elements 212 or other wagering tokens (e.g., cash) within designated areas on the gaming surface 202 associated with the various wagers of the wagering game. Once initial wagers have been accepted, the dealer 216 may remove physical cards 206 from the card-handling device 204 (e.g., individual cards, packets of cards, or the complete set of cards) in some embodiments. In other embodiments, the physical cards 206 may be hand-pitched (i.e., the dealer 216 may optionally shuffle the cards 206 to randomize the set and may hand-deal cards 206 from the randomized set of cards). The dealer 216 may position cards 206 within designated areas on the gaming surface 202, which may designate the cards 206 for use as individual player cards, community cards, or dealer cards in accordance with game rules. House rules also may allow the player to place wagers during card distribution, or after card distribution, but before revealing the cards.

After dealing the cards 206, and during play, according to the game rules, any additional wagers (e.g., play bets) may be accepted, which may be reflected by the dealer 216 permitting the player to place one or more wagering elements 212 within designated areas on the gaming surface 202 associated with the various wagers of the wagering game. In some embodiments, a player may fold, which may result in the dealer 216 collecting at least one of the wagering elements 212 from that player and transferring it to the house, which may be reflected by the wagering element 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering elements 212 from the chip rack 208 to the players, and transferring losing wagers to the house, which may be accomplished by moving wagering elements 212 from the players to the chip rack 208.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

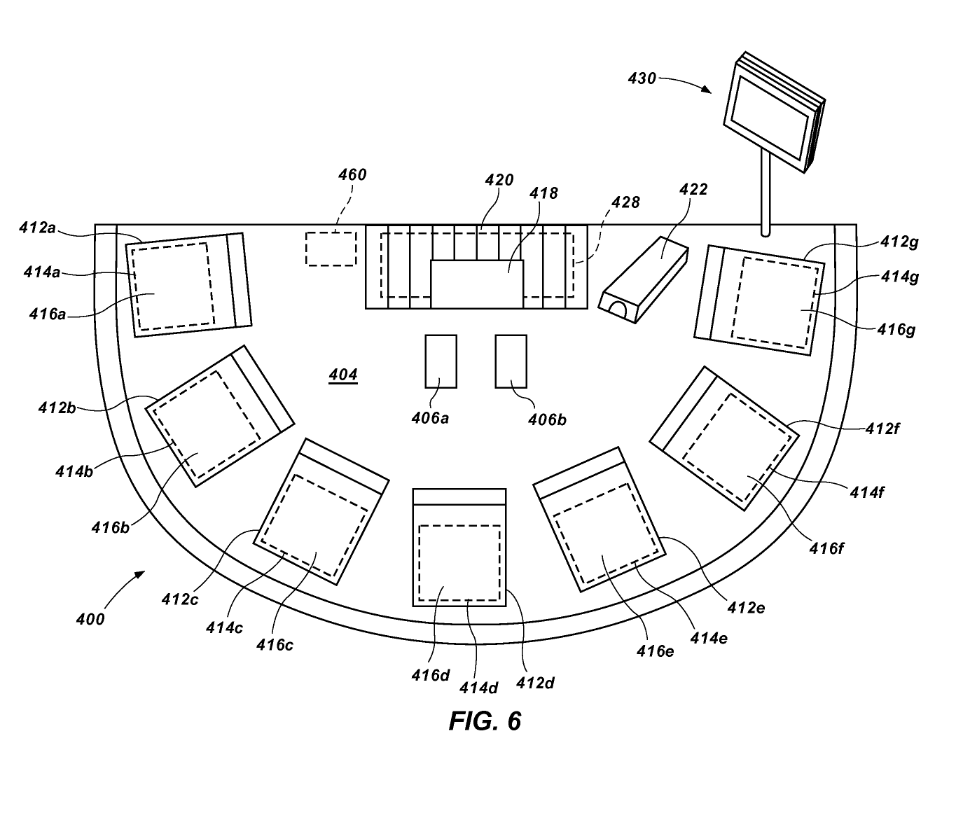

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc.) and accepting player elections. The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed. Each of the processors 414 and 428 may be operably coupled to memory including one or more programs related to the rules of game play at the table 400.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

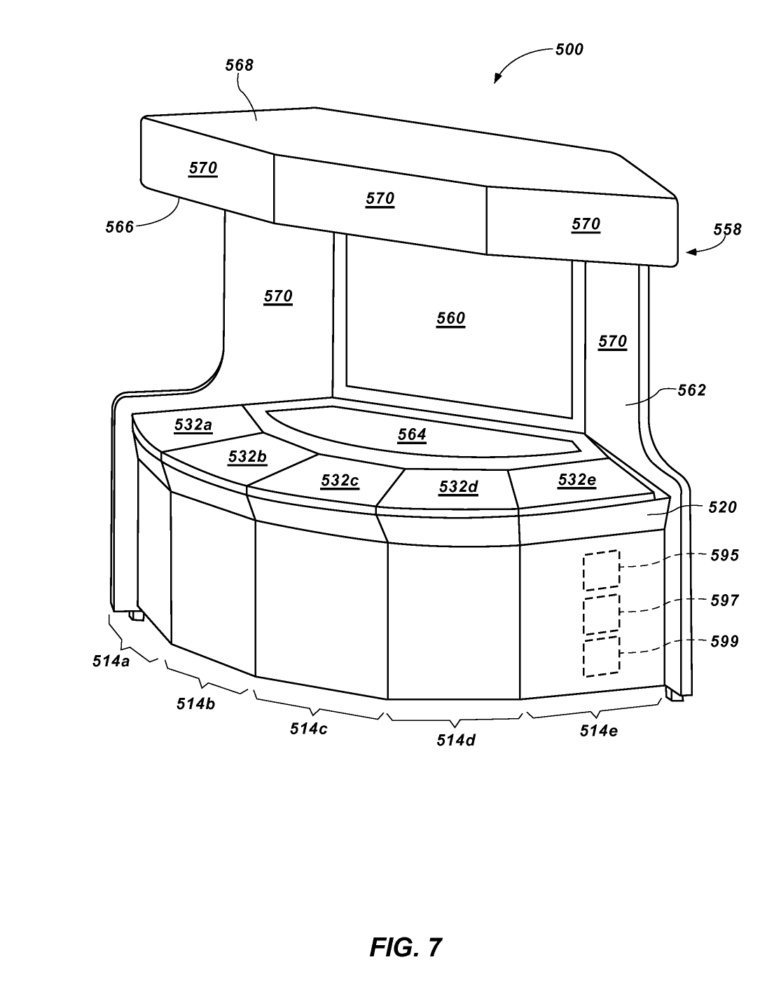

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated by one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, non-limiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

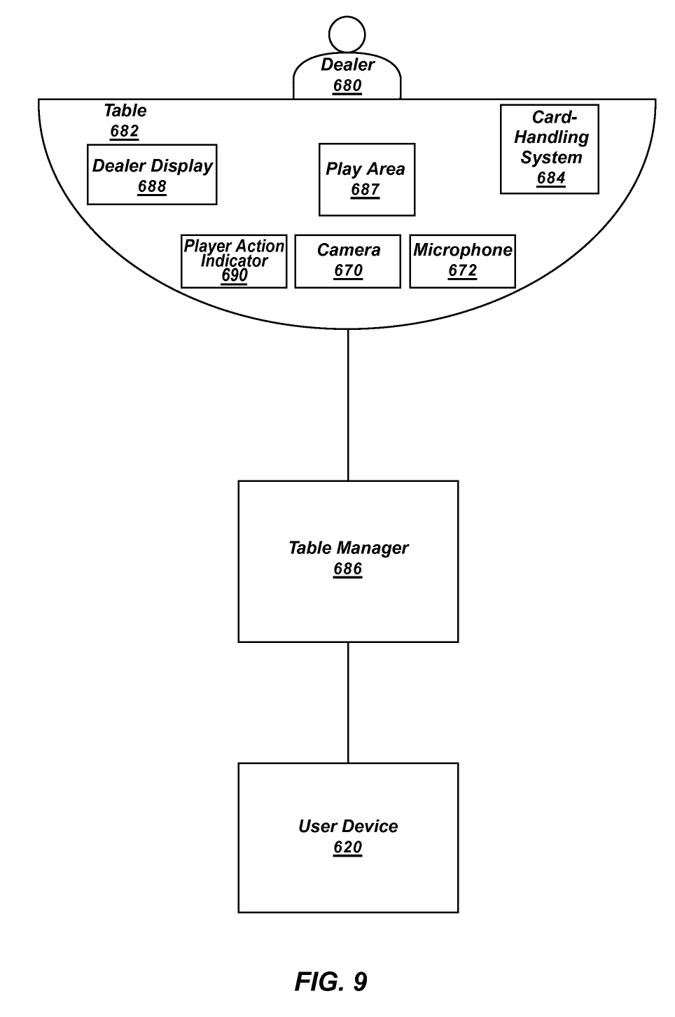

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by computerized random processes, physical cards (e.g., from a standard, 52-card deck of playing cards) may be dealt by a live dealer 680 at a table 682 from a card-handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card-handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card-handling system 684 may be as shown and described previously in connection with FIG. 4. The play area 687 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card-handling system 684 to identify cards dealt by the card-handling system 684. For example, the card-handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

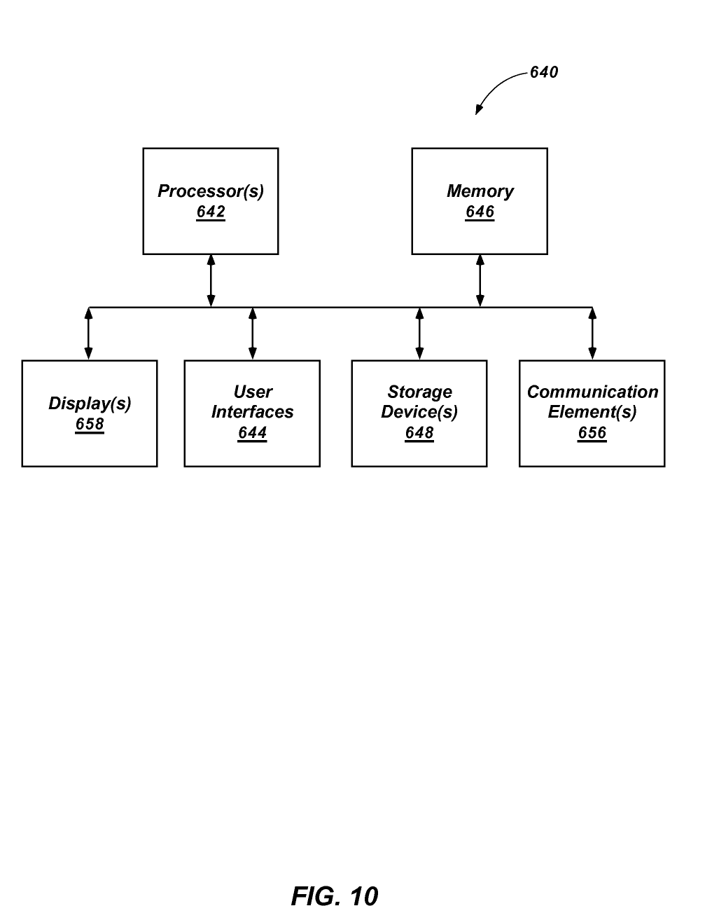

FIG. 10 is a simplified block diagram showing elements of computing devices that may be used in systems and apparatuses of this disclosure. A computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The processors 642 may be configured as a general-purpose processor such as a microprocessor, but in the alternative, the general-purpose processor may be any processor, controller, microcontroller, or state machine suitable for carrying out processes of the present disclosure. The processor 642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light-emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push-buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, THUNDERBOLT™ connections, BLUETOOTH® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one non-limiting example, the memory 646 may be divided into cache memory, graphics memory, and main memory. Each of these memories may communicate directly or indirectly with the one or more processors 642 on separate buses, partially combined buses, or a common bus.

As a specific, non-limiting example, various methods and features of the present disclosure may be implemented in a mobile, remote, or mobile and remote environment over one or more of Internet, cellular communication (e.g., Broadband), near field communication networks and other communication networks referred to collectively herein as an iGaming environment. The iGaming environment may be accessed through social media environments such as FACEBOOK® and the like. DragonPlay Ltd, acquired by Bally Technologies Inc., provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted the features can be expressed as entertainment only gaming where players wager virtual credits having no value or risk no wager whatsoever such as playing a promotion game or feature.

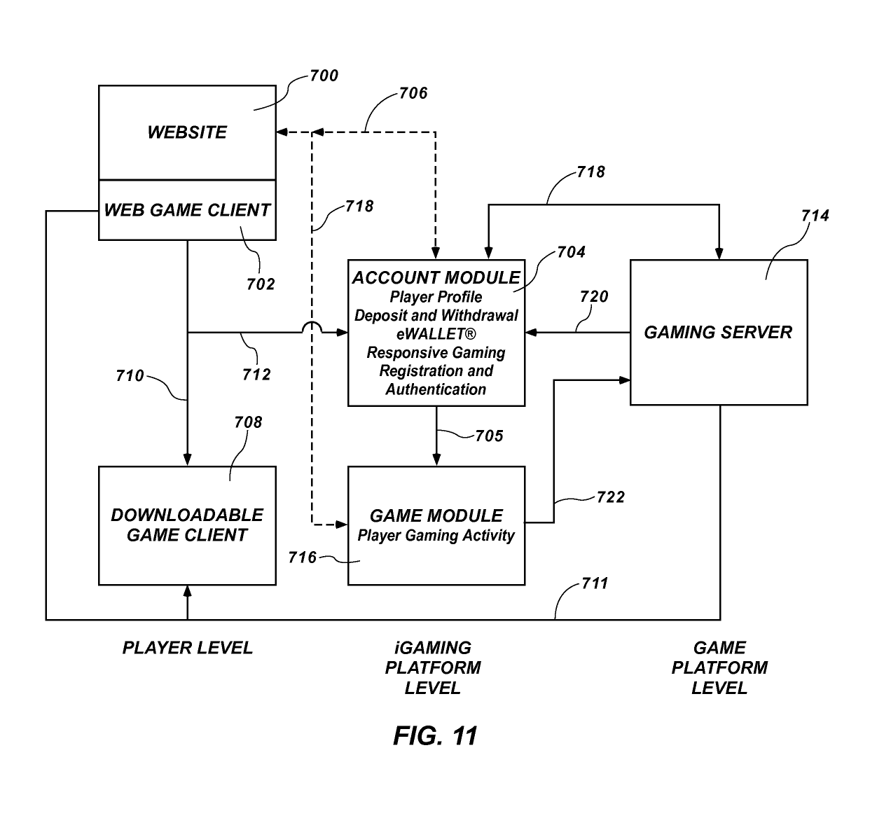

FIG. 11 illustrates an illustrative embodiment of information flows in an iGaming environment. At a player level, the player or user accesses a site hosting the activity such as a website 700. The website 700 may functionally provide a web game client 702. The web game client 702 may be, for example, represented by a game client 708 downloadable at information flow 710, which may process applets transmitted from a gaming server 714 at information flow 711 for rendering and processing game play at a player's remote device. Where the game is a P2P game, the gaming server 714 may process value-based wagers (e.g., money wagers) and randomly generate an outcome for rendition at the player's device. In some embodiments, the web game client 702 may access a local memory store to drive the graphic display at the player's device. In other embodiments, all or a portion of the game graphics may be streamed to the player's device with the web game client 702 enabling player interaction and display of game features and outcomes at the player's device.

The website 700 may access a player-centric, iGaming-platform-level account module 704 at information flow 706 for the player to establish and confirm credentials for play and, where permitted, access an account (e.g., an eWallet) for wagering. The account module 704 may include or access data related to the player's profile (e.g., player-centric information desired to be retained and tracked by the host), the player's electronic account, deposit, and withdrawal records, registration and authentication information, such as username and password, name and address information, date of birth, a copy of a government issued identification document, such as a driver's license or passport, and biometric identification criteria, such as fingerprint or facial recognition data, and a responsible gaming module containing information, such as self-imposed or jurisdictionally imposed gaming restraints, such as loss limits, daily limits and duration limits. The account module 704 may also contain and enforce geo-location limits, such as geographic areas where the player may play P2P games, user device IP address confirmation, and the like.

The account module 704 communicates at information flow 705 with a game module 716 to complete log-ins, registrations, and other activities. The game module 716 may also store or access a player's gaming history, such as player tracking and loyalty club account information. The game module 716 may provide static web pages to the player's device from the game module 716 through information flow 718, whereas, as stated above, the live game content may be provided from the gaming server 714 to the web game client through information flow 711.

The gaming server 714 may be configured to provide interaction between the game and the player, such as receiving wager information, game selection, inter-game player selections or choices to play a game to its conclusion, and the random selection of game outcomes and graphics packages, which, alone or in conjunction with the downloadable game client 708 web game client 702 and game module 716, provide for the display of game graphics and player interactive interfaces. At information flow 718, player account and log-in information may be provided to the gaming server 714 from the account module 704 to enable gaming. Information flow 720 provides wager/credit information between the account module 704 and gaming server 714 for the play of the game and may display credits and eWallet availability. Information flow 722 may provide player tracking information for the gaming server 714 for tracking the player's play. The tracking of play may be used for purposes of providing loyalty rewards to a player, determining preferences, and the like.

All or portions of the features of FIG. 11 may be supported by servers and databases located remotely from a player's mobile device and may be hosted or sponsored by regulated gaming entity for P2P gaming or, where P2P is not permitted, for entertainment only play.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the pay wager, the raise wager, the hand comparison wager, the hand composition wager, and the optional progressive wager) of no real-world monetary value, and payouts (e.g., the pay wager, the raise wager, the hand comparison wager, the hand composition wager, and the optional progressive wager) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

### EXAMPLE

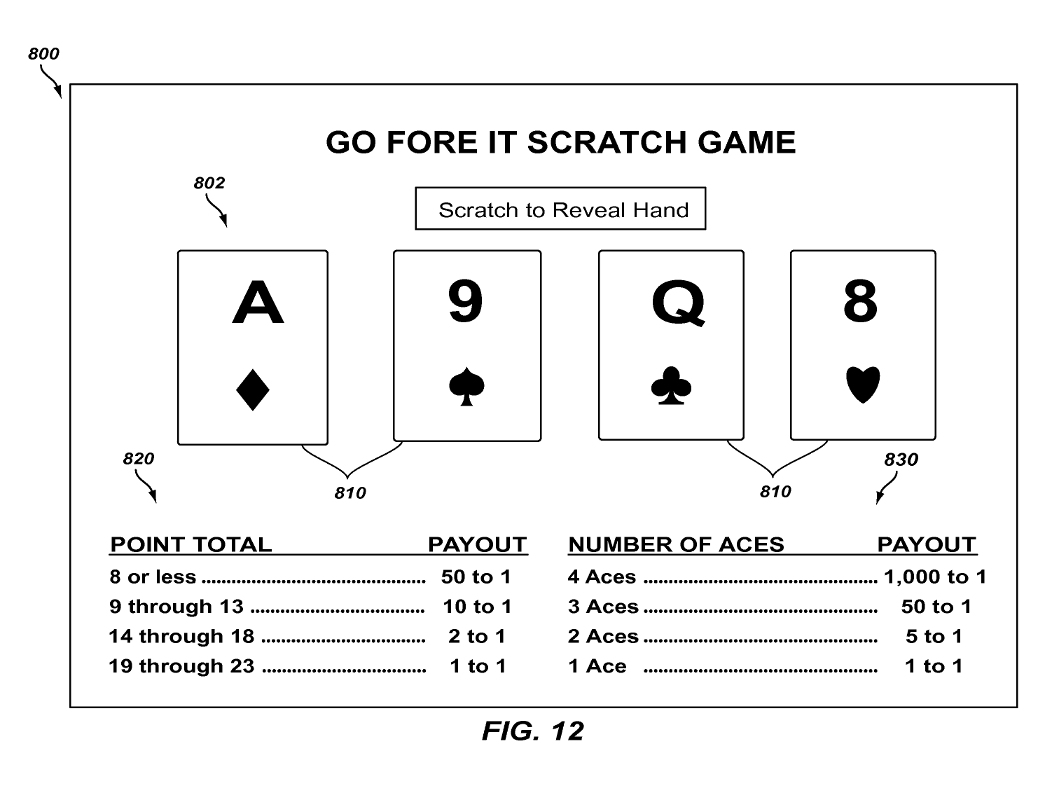

With reference to FIG. 12, a schematic diagram of a wagering game implemented as a scratch card 800 is shown, according to an embodiment of the present disclosure. The scratch card 800 may be implemented as a physical scratch card or a digital scratch card, for example. If the scratch card 800 is a physical scratch card, then representations of cards may be initially covered by an opaque scratch-off covering that may be removed by, for example, scratching off the covering with a coin, fingernail, etc., as is known in the art. If the scratch card 800 is a digital scratch card, then representations of cards may be obscured digitally, or may be stored only in memory, and the representations of cards may be revealed or shown by selecting the location of the representation of cards (e.g., by a mouse click, touching a touch screen, toggling through the representations then selecting “enter,” etc.) or by effecting a motion that represents scratching (e.g., by holding down a mouse button and passing a digital cursor back and forth across the representation, by back and forth motions with a finger on a touch screen, etc.).

The scratch card 800 may include a card area 802 in which representations of cards 810 are to be positioned. In the embodiment shown in FIG. 12, the card area 802 includes four representations of cards 810. Although the rank and suit of the representations of cards are shown in FIG. 12 for ease of explanation, when a participating player initially purchases the scratch card 800, the rank and suit of the representations of cards 810 may be obscured and undetectable by the participating player.

If the scratch card 800 is a physical scratch card, the rank and suit of each representation of card 810 may be determined by a random number generator at the time of printing the scratch card 800. If the scratch card 800 is a digital scratch card implemented on a computer system or network, for example, the rank and suit of each representation of card 810 may be determined by a random number generator associated with the digital scratch card and/or the computer system or network that implements the digital scratch card 800.

Referring to FIG. 12, a participating player may purchase the scratch card 800 from an establishment for a fixed price of $1 (or another fixed price), for example. This wager is equivalent to a wager on the hand total being 23 or lower (the play wager) and the player hand holding an ace (the composition bet). In this example there is no dealer hand, no fold or raise bet election and no comparison bet. To illustrate how the exemplary wagering game is played using the scratch card 800, the participating player may reveal the requisite number (e.g., four in the embodiment shown in FIG. 12) of representations of player cards 810 in the card area 802. For purposes of illustration and by way of non-limiting example, the revealed representations of cards 810 in the card area 802 may be an ace of diamonds, a 9 of spades, a queen of clubs, and an 8 of hearts. With these revealed representations of cards 810, the complete player hand point total may be twenty-eight which exceeds the maximum of 23 to win. Although not depicted, the scratch card 800 may include a table describing the point values of each of the cards 810, as discussed above. Thus, the player will not win a payout according to pay table 820. However, the player has won a payout of 1:1 (e.g., based on the amount paid for the scratch card 800) based on the hand composition pay table 830 because the complete player hand includes one ace and the establishment from which the scratch card 800 was purchased or another establishment responsible for providing payouts may accept the scratch card 800 and pay an appropriate payout to the participating player according to the hand composition pay table 830.

Although the scratch card 800 has been described as being sold for a fixed price and as providing fixed payouts, the present disclosure is not so limited. For example, the scratch card 800 may be offered for sale at a variable price, and the pay table 820 may provide odds or multiples of the paid price as potential payouts. A purchase price at which a particular scratch card 800 is bought may be printed on the scratch card 800 at the time of sale. Thus, a participating player may wager more on the scratch card 800 by paying a higher price for the scratch card 800, and may qualify for higher payouts if a winning hand is achieved with the scratch card 800 purchased for a higher price.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventors.

What is claimed is:

1. A method of administering a wagering game, comprising:
accepting at least one of:
a play wager from a player to participate in a game by receiving at least a first tangible, monetarily valuable gaming chip in a designated play wager area on a play surface of a play table;
a hand comparison wager from the player to participate in a hand comparison game by receiving at least a second tangible, monetarily valuable gaming chip in a designated hand comparison wager area on the play surface of the play table; and
a hand composition wager from the player to participating in a hand composition game by receiving at least a third tangible, monetarily valuable gaming chip in a designated hand composition wager area on the play surface of the play table;
delivering player cards from a deck of physical playing cards comprising a set of at least one 52-card deck of standard playing cards from a card-handling device configured to present randomized cards for delivery to the player in a player card receiving area on the play surface of the play table to form a partial player hand;
allowing the player to inspect the partial player hand;
if the player has placed the play wager, accepting an optional raise wager from the player by receiving at least a fourth tangible, monetarily valuable gaming chip in a raise wager area on the play surface of the play table or receiving an indication of folding from the player;
delivering additional player cards from the card-handling device to the player in the player card receiving area on the play surface of the play table to form a complete player hand if the player placed at least one of the hand comparison wager, the hand composition wager, and the raise wager;
delivering a set of dealer cards from the card-handling device to a dealer card receiving area on the play surface of the play table;
resolving the play wager by paying the player a payout on the play wager when a player point total of the complete player hand is less than or equal to a predetermined value;
resolving the raise wager if the player has placed the raise wager by paying the player a payout on the raise wager when the player point total of the complete player hand is less than or equal to the predetermined value;
resolving the hand comparison wager by paying the player a payout on the hand comparison wager when the player point total of the complete player hand is less than or equal to a predetermined point total of the set of dealer cards; and
resolving the hand composition wager by paying the player a payout on the hand composition wager when the complete player hand includes at least one ace.

2. The method of claim 1, wherein delivering player cards to form a partial player hand comprises delivering two player cards in the player card receiving area on the play surface of the play table.

3. The method of claim 1, wherein delivering additional player cards from the card-handling device to the player comprises dealing another two player cards in the player card receiving area on the play surface of the play table.

4. The method of claim 1, wherein delivering a set of dealer cards comprises dealing four cards to the dealer card receiving area on the play surface of the play table.

5. The method of claim 1, wherein resolving the play wager by paying the player a payout on the play wager when a player point total of the complete player hand is less than or equal to a predetermined value comprises paying the player the payout on the play wager when the player point total of the complete player hand is less than or equal to twenty-three.

6. The method of claim 5, wherein resolving the raise wager by paying the player a payout on the raise wager when the player point total of the complete player hand is less than or equal to the predetermined value comprises paying the player the payout on the raise wager when the player point total of the complete player hand is less than or equal to twenty-three.

7. The method of claim 6, wherein paying the player the payout on the raise wager comprises paving the player the payout on the raise wager according to the following pay table:

| Player Point Total | Raise Wager Payout |
|---|---|
| 19 through 23 | 1 to 1 |
| 14 through 18 | 2 to 1 |
| 9 through 13 | 10 to 1 |
| 4 through 8 | 50 to 1 |

8. The method of claim 1, wherein resolving the hand comparison wager by paying the player a payout on the hand comparison wager when the player point total of the complete player hand is less than a point total of the set of dealer cards comprises paying the payout on the hand comparison wager at 1:1 odds.

9. The method of claim 1, wherein resolving the hand composition wager by paying the player a payout on the hand composition wager when the complete player hand includes at least one ace comprises paying the payout on the hand composition wager according to the following pay table:

| Number of Aces | Hand Composition |
|---|---|
| in Player Hand | Wager Payout |
| 1 | 2 to 1 |
| 2 | 5 to 1 |
| 3 | 50 to 1 |
| 4 | 1,000 to 1 |

10. The method of claim 1, wherein paying the player a payout on the hand composition wager comprises paying the player a progressive payout when the complete player hand includes four aces.

11. The method of claim 1, wherein the play wager is mandatory.

12. The method of claim 1, wherein the predetermined value is selected from the set consisting of twenty-three and twenty-four.

13. A method of administering a wagering game, comprising:
providing a playing device layout comprising at least one player position and a dealer area, the at least one player position of the playing device layout including a play wager area, a raise wager area, a hand comparison wager area, and a hand composition wager area, the play wager area, the raise wager area, the hand comparison wager area, and the hand composition wager area each defined by separate insignia displayed on the playing device layout, the dealer area including a dealer card receiving area;
accepting at least one of a play wager of at least one tangible, monetarily valuable gaming chip from at least one player at the play wager area, a hand comparison wager of at least one tangible, monetarily valuable gaming chip at the hand comparison wager area, and a hand composition wager of at least one tangible, monetarily valuable gaming chip at the hand composition wager area from the at least one player;
dealing player cards to the at least one player to form at least a portion of a player hand from a set of physical playing cards comprising at least one 52-card deck of standard playing cards utilizing a card-handling device configured to present cards for delivery;
allowing the at least one player to inspect at least one card of the player hand;
accepting a raise wager of at least one tangible, monetarily valuable gaming chip at the raise wager area from the at least one player;
allowing the at least one player to inspect a remaining portion of the player hand;
dealing dealer cards to a dealer at the dealer card receiving area from the card-handling device;
determining a player point total of the player hand;
determining a dealer point total of the dealer cards;
paying a payout of at least one tangible, monetarily valuable gaming chip on at least one of the play wager and the raise wager when the player point total is less than or equal to a predetermined point total;
paying a hand comparison wager payout of at least one tangible, monetarily valuable gaming chip on the hand comparison wager if the player point total is less than the dealer point total; and
paying a hand composition wager payout of at least one tangible, monetarily valuable gaming chip on the hand composition wager if the player hand includes at least one predetermined card value.

14. The method of claim 13, further comprising retaining the play wager and the raise wager if the player point total is greater than the predetermined point total.

15. The method of claim 13, wherein:
allowing the at least one player to inspect at least one card of the player hand comprises allowing the at least one player to inspect two cards of the player hand:
allowing the at least one player to inspect a remaining portion of the player hand comprises allowing the at least one player to inspect two remaining cards of the player hand; and
dealing dealer cards to a dealer comprises dealing four dealer cards to the dealer.

16. The method of claim 13, further comprising paying the at least one player a progressive payout when the at least one player places the hand composition wager and the player hand includes four aces.

17. The method of claim 13, wherein paying a payout of at least one tangible, monetarily valuable gaming chip on at least one of the play wager and the raise wager when the player point total is less than or equal to a predetermined point total comprises:
selecting the payout on the play wager to be 1:1; and
selecting the payout on the raise wager to be an odds based payout based on the player point total of the player hand, the payout on the raise wager being higher for lower player point totals.

18. The method of claim 13, wherein paying a payout of at least one tangible, monetarily valuable gaming chip on at least one of the play wager and the raise wager when the player point total is less than or equal to a predetermined point total comprises paying the payout when the predetermined point total is less than or equal to at least one of twenty-three and twenty-four.

19. The method of claim 15, further comprising paying a payout of at least one tangible, monetarily valuable gaming chip on the hand composition wager to the at least one player according to the following pay table:

| Player Hand Poker Rank | Hand Composition Payout |
|---|---|
| Three of a Kind | 9 to 1 |
| Straight Flush | 100 to 1 |
| Four of a Kind | 300 to 1 |
| Four Aces | Progressive Payout |

20. The method of claim 15, further comprising:
accepting a progressive wager of at least one tangible, monetarily valuable gaming chip from the at least one player at a progressive wager area; and
paying a progressive wager payout of at least one tangible, monetarily valuable gaming chip on the progressive wager if the player hand includes at least one of a three of a kind, a straight flush, a four of a kind, and four aces.

21. A method of administering a wagering game over a network utilizing a processor, comprising:
receiving, at a server comprising at least one processor, an electronic signal indicating that at least one of a play wager, a hand comparison wager, and a hand composition wager is accepted from a player;
determining, utilizing the server, a partial player hand to the player, the partial player hand including at least two playing cards from a deck of playing cards comprising at least a 52-card set of standard playing cards;
providing, with the server, the partial player hand to a user device associated with the player for displaying the partial player hand on the associated user device;
determining, utilizing the server, a complete player hand comprising the at least two player cards and additional player cards;
providing, with the server, the complete player hand to the user device associated with the player for displaying the complete player hand on the associated user device;
determining, utilizing the server, a dealer hand from the deck of playing cards;
providing, with the server, the dealer hand to the user device associated with the player for displaying the dealer hand on the associated user device; and
resolving, with the server, at least one of:
authorizing, at the server, payment of a play wager payout to the player when a player point total of the complete player hand is lower than or equal to a predetermined point total;
authorizing, at the server, payment of a hand comparison wager payout when the point total of the complete player hand is lower than a point total of the dealer hand; and
authorizing, at the server, payment of a hand composition wager payout when the complete player hand includes at least one ace.

22. The method of claim 21, further comprising receiving, at the server, an electronic signal that a raise wager is accepted from the player after the partial player hand has been displayed on the associated user device.

23. The method of claim 13, wherein the predetermined card value is an ace.
